(19) United States
(12) Patent Application Publication
(10) Pub. No.: US 2024/0043619 A1
(43) Pub. Date: Feb. 8, 2024

(54) POLYIMIDE PRECURSOR RESIN COMPOSITION

(71) Applicant: ASAHI KASEI KABUSHIKI KAISHA, Tokyo (JP)

(72) Inventors: Takayuki KANADA, Tokyo (JP); Masaki MAITANI, Tokyo (JP); Toshiaki OKUDA, Tokyo (JP)

(73) Assignee: ASAHI KASEI KABUSHIKI KAISHA, Tokyo (JP)

(21) Appl. No.: 18/377,194

(22) Filed: Oct. 5, 2023

Related U.S. Application Data
(62) Division of application No. 16/448,386, filed on Jun. 21, 2019.

(30) Foreign Application Priority Data
Jun. 28, 2018 (JP) 2018-123660
May 31, 2019 (JP) 2019-102296

(51) Int. Cl. C08G 73/10; C08J 5/18; B29C 41/46; B29C 41/00; C09D 179/08

(52) U.S. Cl. CPC C08G 73/106; C08G 73/1082; C08G 73/1078; C08G 73/1032; C08J 5/18; B29C 41/46; B29C 41/003; C09D 179/08; B29L 2031/3475

(57) ABSTRACT

Problem: The invention provides a polyimide precursor as well as a resin composition thereof that is excellent in coating properties of slit coating as well as productivity and also excellent in optical properties that are required for applications of flexible substrates.

Solution: The polyimide precursor comprises a structure unit derived from a fluorene backbone and a silicon-containing structure unit, and a weight-average molecular weight of the polyimide precursor is 90,000 to 250,000.

### 1. POLYIMIDE PRECURSOR RESIN COMPOSITION

This is a Divisional application of U.S. patent application Ser. No. 16/448,386 filed Jun. 21, 2019, and claims the priority benefit of Japanese Application 2018-123660 filed Jun. 28, 2018 and Japanese Application 2019-102296 filed May 31, 2019, the contents of each of the above documents are expressly incorporated by reference herein in their entireties.

### BACKGROUND OF THE INVENTION

### 1. Field of the Invention

The present invention relates to a polyimide precursor and a resin composition thereof, a polyimide film and a method for manufacturing the same, a laminate and a method for manufacturing the same, and a display substrate and a method for manufacturing the same.

### 2. Description of the Related Art

A polyimide resin is an insoluble or infusible super heat-resistant resin and has been used in a wide range of fields including electronic materials since it has excellent properties such as thermal oxidation resistance, heat resistance, radiation resistance, low temperature resistance, chemical resistance, etc.

Examples of applications of the polyimide resin in a field of electronic materials include dielectric coating materials, dielectric films, semiconductors, electrode protective films for a TFT-LCD, etc. In recent years, an application of the polyimide resin as flexible substrates utilizing lightness or flexibility of the polyimide resin has also been considered in place of glass substrates conventionally used in a field of display materials.

PTL 1 discloses, for example, a resin precursor (weight average-molecular weight: 30,000 to 90,000) polymerized from bis(diaminodiphenyl)sulfone and having siloxane units, and also discloses polyimide obtained by curing the resin precursor has a low residual stress generated with a support such as glass, etc., excellent chemical resistance, and also small influence on a YI value and total light transmittance associated with an oxygen concentration upon a curing step. Moreover, PTL 2 describes that polyimide obtained by using a monomer having a fluorene skeleton and is cured from a polyimide precursor having a siloxane unit, is excellent in the YI, Haze and heat resistance. PTLs 3 and 4 describe polyimide that is cured from polyamide acid obtained using a monomer having a fluorene skeleton, is excellent in transparency, thermal properties and mechanical properties (after moisture absorption) and is suitably used for a flexible display.

### CITATION LIST

### Patent Literature

[PTL 1] WO2014/148441
[PTL 2] Korean Patent No. 10-1787941
[PTL 3] WO2014/007112
[PTL 4] WO2016/088641

### SUMMARY OF THE INVENTION

When a transparent polyimide resin is to be applied to a flexible substrate, a desired product is obtained by coating a surface of a substrate such as a glass substrate, etc., as a support with a resin composition containing a polyimide precursor to form a coating film, then drying by heating, further, imidizing the polyimide precursor to form a polyimide film, and if necessary, forming a device on the film, then stripping the film from the glass substrate, etc.

In recent years, with the increase in size of displays, etc., which is an application of flexible substrates, when a surface of a substrate such as a glass substrate, etc., is coated with a resin composition containing a polyimide precursor, a slit coater is often used. In the case of coating by the slit coater, as a parameter affecting the film to be coated, a coater gap (i.e., a set value regulating the distance between a glass substrate and a slit nozzle) is one thereof, and as the coater gap becomes smaller and flatness of the glass substrate is poor, the nozzle may contact with the substrate and there may be a likelihood of breakage of the slit nozzle. In particular, with the recent increase in size of displays, etc., it has become necessary to render the coater gap sufficiently large.

The present inventors have found that when using a polyimide precursor having the same molecular weight and backbone as those described in PTLs 2 to 4, and evaluating coatability of slit coating, the coating properties were insufficient

Accordingly, an object of the present invention is to provide a polyimide precursor as well as a resin composition thereof that is favorable in coating properties of slit coating and excellent in productivity, and is also excellent in optical properties that are required for applications of flexible substrates.

The present inventors have carried out much diligent experimentation with the aim of solving the problems described above. As a result, the present inventors have found that by specifying a molecular weight of a polyimide precursor having a fluorene backbone and a siloxane unit and/or specifying a content of a silicon-containing compound in a resin composition, not only coating properties of slit coating are favorable and productivity thereof is excellent, but also optical properties required for applications of flexible substrates are excellent and thus have completed the present invention. Examples of the embodiments of the present invention are as described below.
[1] A polyimide precursor represented by formula (1):

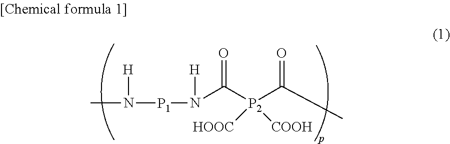

wherein P₁ represents a divalent organic group, if P₁ is plural, P₁ each may be the same or different, P₂ represents a tetravalent group represented by formula (2):

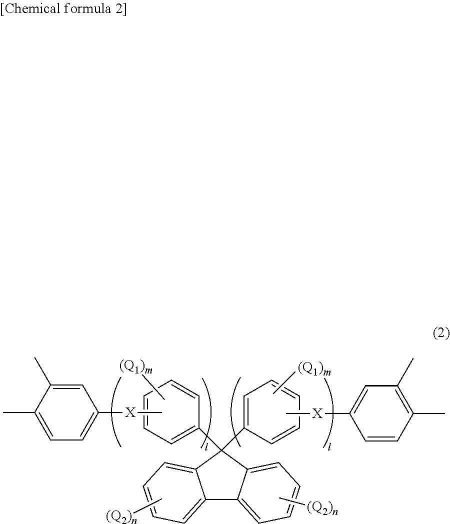

wherein Q₁ and Q₂ are each independently at least one selected from the group consisting of an alkyl group, an aryl group, an arylalkyl group and a halogenated alkyl group, X is each independently at least one selected from the group consisting of —O—, —C(═O)—, —C(═O)O— and —C(═O)NH—, m and n are each independently an integer of 0 to 2, and 1 is an integer of 0 or 1; if P₂ is plural, P₂ each may be the same or different, and p is a positive integer, wherein the polyimide precursor has a structure unit represented by formula (3):

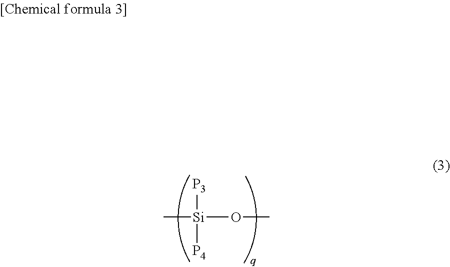

wherein P₃ and P₄ are each independently a monovalent aliphatic hydrocarbon group of 1 to 5 carbon atoms or a monovalent aromatic group of 6 to 10 carbon atoms, if P₃ is plural, P₃ each may be the same or different, if P₄ is plural, P₄ each may be the same or different, and q is a positive integer, and has a weight-average molecular weight of 90,000 to 250,000.
[2] The polyimide precursor according to [1], wherein the weight-average molecular weight of the polyimide precursor is more than 96,000.
[3] The polyimide precursor according to [1] or [2], the tetravalent group represented by formula (2) is a residue group of 9,9-bis(3,4-dicarboxyphenyl)fluorene dianhydride, or 9,9-bis[4-(3,4-dicarboxyphenoxy)phenyl]fluorene dianhydride.
[4] The polyimide precursor according to any one of [1] to [3], wherein the polyimide precursor is a copolymer of tetracarboxylic dianhydride and diamine, and the tetracarboxylic dianhydride contains at least one of pyromellitic dianhydride and 3,3′,4,4′-biphenyltetracarboxylic dianhydride.
[5] The polyimide precursor according to any one of [1] to [4], wherein the diamine contains at least one selected from the group consisting of
   2,2′-diaminobis(trifluoromethyl)biphenyl,
   4,4′ and/or 3,3′-diaminodiphenyl sulfone,
   9,9-bis(4-aminophenyl)fluorene, and
   1,4-diaminocyclohexane.
[6] The polyimide precursor according to any one of [1] to [5], wherein the weight-average molecular weight of the polyimide precursor is 200,000 or less.
[7] The polyimide precursor according to any one of [1] to [6], wherein the weight-average molecular weight of the polyimide precursor is 110,000 to 200,000.
[8] The polyimide precursor according to any one of [1] to [7], wherein the weight-average molecular weight of the polyimide precursor is 180,000 or less.
[9] The polyimide precursor according to any one of [1] to [8], wherein the weight-average molecular weight of the polyimide precursor is 139,000 or more.
[10] A resin composition comprising:
   the polyimide precursor according to any one of [1] to [9]; and
   a solvent.
[11] A resin composition comprising a polyimide precursor and a solvent, wherein the polyimide precursor is represented by formula (1):

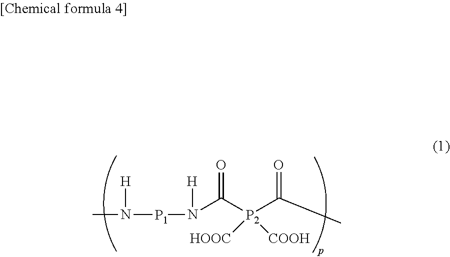

wherein P₁ represents a divalent organic group, if P₁ is plural, P₁ each may be the same or different, P₂ represents a tetravalent group represented by formula (2):

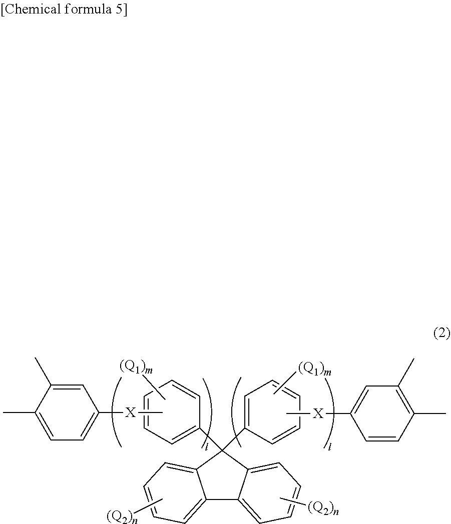

wherein Q₁ and Q₂ are each independently at least one selected from the group consisting of an alkyl group, an aryl group, an arylalkyl group and a halogenated alkyl group, X is each independently at least one selected from the group consisting of —O—, —C(═O)—, —C(═O)O— and —C(═O)NH—, m and n are each independently an integer of 0 to 2, and 1 is an integer of 0 or 1; if P₂ is plural, P₂ each may be the same or different and p is a positive integer, and has a structure unit represented by formula (3):

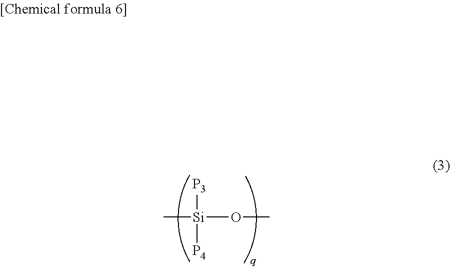

wherein P₃ and P₄ are each independently a monovalent aliphatic hydrocarbon group of 1 to 5 carbon atoms or a monovalent aromatic group of 6 to 10 carbon atoms, if P₃ is plural, P₃ each may be the same or different, if P₄ is plural, P₄ each may be the same or different and q is a positive integer, and
the resin composition comprises a compound represented by formula (4):

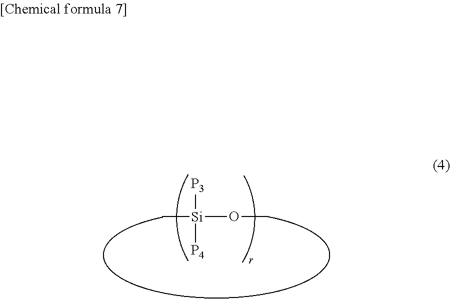

wherein P₅ and P₆ are each independently a monovalent aliphatic hydrocarbon of 1 to 5 carbon atoms or an aromatic group of 6 to 10 carbon atoms and r is an integer of 3 or more, in an amount of greater than 0 ppm and 300 ppm or less based on a weight of the resin composition,
and/or in an amount of greater than 0 ppm and 1500 ppm or less based on a solid content weight in the resin composition.
[12] A resin composition comprising a polyimide precursor and a solvent, wherein the polyimide precursor is represented by formula (1):

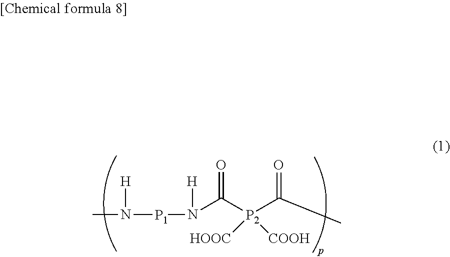

wherein P₁ represents a divalent organic group, if P₁ is plural, P₁ each may be the same or different, P₂ represents a tetravalent group represented by formula (2):

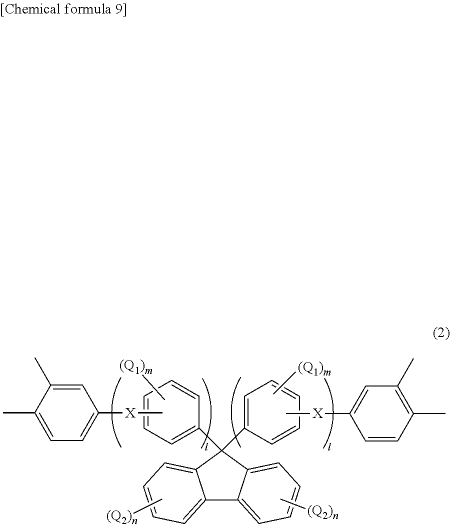

wherein Q₁ and Q₂ are each independently at least one selected from the group consisting of an alkyl group, an aryl group, an arylalkyl group and a halogenated alkyl group, X is each independently at least one selected from the group consisting of —O—, —C(═O)—, —C(═O)O— and —C(═O)NH—, m and n are each independently an integer of 0 to 2, and 1 is an integer of 0 or 1; if P₂ is plural, P₂ each may be the same or different and p is a positive integer, and has a structure unit represented by formula (3):

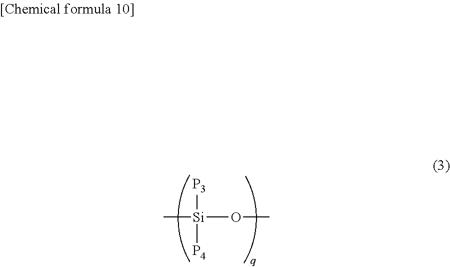

wherein P₃ and P₄ are each independently a monovalent aliphatic hydrocarbon group of 1 to 5 carbon atoms or a monovalent aromatic group of 6 to 10 carbon atoms, if P₃ is plural, P₃ each may be the same or different, if P₄ is plural, P₄ each may be the same or different and q is a positive integer,
the resin composition comprises a compound represented by formula (4):

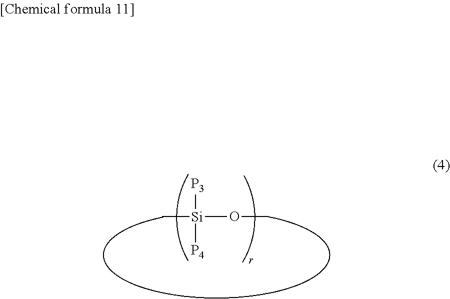

wherein P₅ and P₆ are each independently a monovalent aliphatic hydrocarbon of 1 to 5 carbon atoms or an aromatic group of 6 to 10 carbon atoms and r is an integer of 3 or more,
the polyimide precursor is a copolymer containing as monomer units:
a silicon-containing compound represented by formula (5):

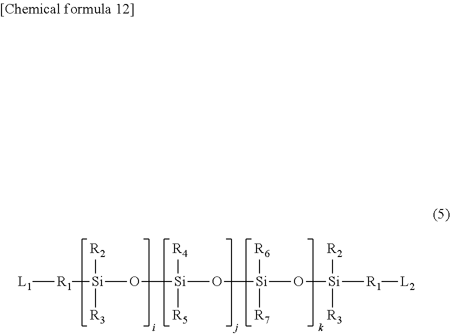

wherein R₁ is each independently, single bond or a divalent organic group of 1 to 10 carbon atoms, R₂ and R₃ are each independently a monovalent aliphatic hydrocarbon group of 1 to 5 carbon atoms, R₄ and R₅ are each independently a monovalent aromatic group of 6 to 10 carbon atoms, R₆ and R₇ are each independently a monovalent organic group of 1 to 10 carbon atoms, at least one of R₆ and R₇ is an organic group having an unsaturated aliphatic hydrocarbon group, L₁ and L₂ are each independently an amino group, an acid anhydride group, an isocyanate group, a carboxy group, an acid ester group, an acid halide group, a hydroxy group, an epoxy group or a mercapto group, i is an integer of 1 to 200, and j and k are each independently an integer of 0 to 200,
tetracarboxylic dianhydride, and
diamine; and
   a content of the compound represented by formula (4) in the resin composition is greater than 0 ppm and 450 ppm or less based on 100 parts by weight of a total weight of the silicon-containing compounds represented by formulas (4) and (5).
[13] The resin composition according to [11] or [12], wherein a weight-average molecular weight of the polyimide precursor is 90,000 to 250,000.
[14] The resin composition according to any one of [11] to [13], wherein a weight-average molecular weight of the polyimide precursor is more than 96,000.
[15] The resin composition according to any one of [11] to [14], wherein a weight-average molecular weight of the polyimide precursor is 139,000 or more and/or 180,000 or less.
[16] The resin composition according to any one of [11] to [15], wherein P₅ and P₆ are each independently a monovalent aliphatic hydrocarbon of 1 to 5 carbon atoms, and r is 3 to 8, in formula (4).
[17] The resin composition according to any one of [11] to [15], wherein P₅ and P₆ are each independently an aromatic group of 6 to 10 carbon atoms, and r is 3 to 8, in formula (4).
[18] The resin composition according to any one of [10] to [17], wherein a solid content of the resin composition is 9 to 25% by weight, 9 to 20% by weight, 9 to 15% by weight, or 9 to 13% by weight.
[19] The resin composition according to any one of [10] to [18], wherein a polyimide resin film which is a cured product of the polyimide precursor is used for a flexible substrate.
[20] The resin composition according to any one of [10] to [19], wherein a polyimide resin film which is a cured product of the polyimide precursor is used for a flexible display.
[21] A method of preparing a polyimide film, comprising:
   a coating step of coating a surface of a support with the resin composition according to any one of [10] to [20];
   a film forming step of forming a polyimide resin film by heating the resin composition; and
   a stripping step of stripping the polyimide resin film from the support.
[22] The method according to [21], which comprises an irradiation step of irradiating a laser to the resin composition from the support side prior to the stripping step.
[23] A method of preparing a display, comprising:
   a coating step of coating a surface of a support with the resin composition according to any one of [10] to [20];
   a film forming step of forming a polyimide resin film by heating the resin composition;
   an element forming step of forming an element on the polyimide resin film; and
   a stripping step of stripping the polyimide resin film on which the element is formed from the support.
[24] A method of preparing a laminate, comprising:
   a coating step of coating a surface of a support with the resin composition according to any one of [10] to [20];
   a film forming step of forming a polyimide resin film by heating the resin composition; and
   an element forming step of forming an element on the polyimide resin film.
[25] The method according to [24], which further comprises a step of stripping the polyimide resin film on which the element is formed from the support.
[26] A method of preparing a flexible device, comprising the step of preparing the laminate according to the method of [24] or [25].
[27] A polyimide film, which is a cured product of the resin composition according to any one of [10] to [20].

The polyimide precursor film or polyimide film according to the present invention is excellent in coating properties of slit coating of a resin composition comprising a polyimide precursor and enables to suppress, for example, liquid leakage from a slit nozzle and liquid drip from a coating film to secure an appropriate coater gap, achieving excellent productivity. Moreover, the polyimide film according to the present invention is also excellent in optical properties required for an application of flexible substrates.

### BRIEF DESCRIPTION OF THE DRAWINGS

FIG. 1 is a schematic diagram illustrating a structure of a Top-emission flexible organic EL display, which is an upper portion of a polyimide substrate, as an example of a display of the present embodiment.

### DETAILED DESCRIPTION OF THE INVENTION

Embodiments for carrying out the present invention (hereunder referred to as “the present embodiment”) will be explained below in more detail. It is to be understood, however, that the present invention is not limited to the following embodiments and may implement various modifications within the scope of the gist thereof. Furthermore, in the present description an upper limit and lower limit for ranges of various characteristic values may be arbitrarily combined.

[Polyimide Precursor]

A polyimide precursor according to the present embodiment is represented by formula (1):

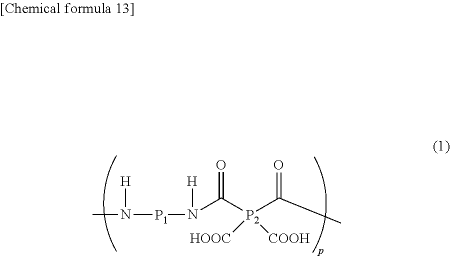

wherein P₁ represents a divalent organic group, if P₁ is plural, P₁ each may be the same or different, P₂ represents a tetravalent group represented by formula (2):

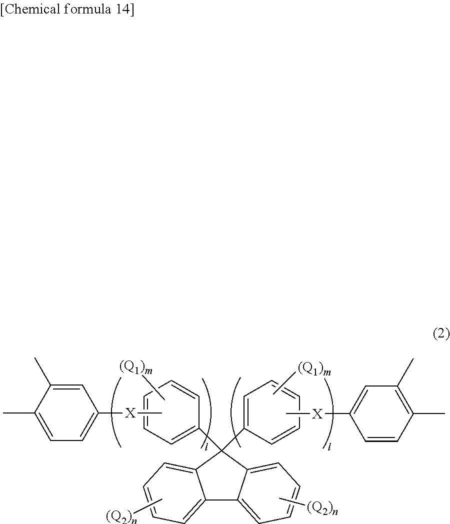

wherein Q₁ and Q₂ are each independently at least one selected from the group consisting of an alkyl group, aryl group, arylalkyl group and halogenated alkyl group, X is each independently at least one selected from the group consisting of —O—, —C(═O)—, —C(═O)O— and —C(═O)NH—, m and n are each independently an integer of 0 to 2, and 1 is an integer of 0 or 1, and if P₂ is plural, P₂ each may be the same or different, p is a positive integer, and has a structure unit represented by formula (3):

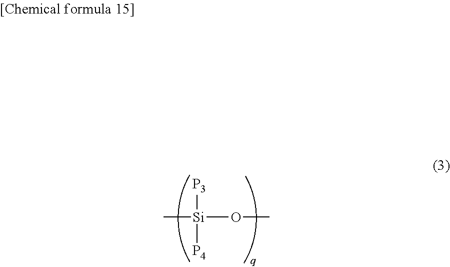

wherein P₃ and P₄ are each independently a monovalent aliphatic hydrocarbon group of 1 to 5 carbon atoms or a monovalent aromatic group of 6 to 10 carbon atoms, if P₃ is plural, P₃ each may be the same or different, if P₄ is plural, P₄ each may be the same or different and q is a positive integer.

While not wishing to be bound by theory, it is conjectured that the polyimide precursor having the fluorene backbone that is superior in bending to the backbone derived from pyromellitic acid or biphenyl tetracarboxylic acid, so that retardation (Rth) in a thickness direction of the polyimide film can be reduced. From the viewpoint of reduction of the retardation (Rth), 1 is preferably 0 in formula (2).

The weight-average molecular weight (Mw) of the polyimide precursor according to the present embodiment is 70,000 or more and 250,000 or less. The Mw of the polyimide precursor is 70,000 or more from the viewpoint of having a range of slit-coatable molecular weights and/or a region of applicable solid contents, thereby being excellent in coating evaluation, and from the viewpoint of coating evaluation and the elongation and YI (yellowness) of a polyimide film obtained by curing a composition comprising the polyimide precursor, it is preferably 90,000 or more, more than 96,000 or 110,000 or more, more preferably 120,000 or more, and furthermore preferably 130,000 or more, or 139,000 or more. In addition, the Mw of the polyimide precursor is 250,000 or less, preferably less than 250,000 from the standpoint on synthesis of the polyimide precursor, and from the standpoint on synthesis and the viewpoint of the haze of the polyimide film, it is more preferably 220,000 or less, furthermore preferably 200,000 or less, and may be 180,000 or less.

In formula (1), p is a positive integer, preferably an integer within the range of 140 to 500, and more preferably an integer within the range of 180 to 440, from the viewpoint of a weight-average molecular weight of the polyimide precursor.

The polyimide precursor represented by formula (1) is preferably a copolymer of acid dianhydride having the P₂ group represented by formula (2) and diamine having the P₁ group, more preferably a copolymer containing as monomer units a silicon-containing compound represented by formula (5):

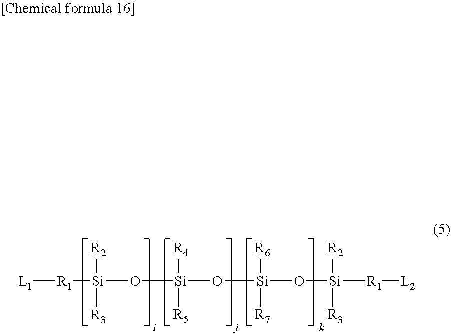

wherein R₁ is each independently, single bond or a divalent organic group of 1 to 10 carbon atoms, R₂ and R₃ are each independently a monovalent aliphatic hydrocarbon group of 1 to 5 carbon atoms, R₄ and R₅ are each independently a monovalent aromatic group of 6 to 10 carbon atoms, R₆ and R₇ are each independently a monovalent organic group of 1 to 10 carbon atoms, at least one of R₆ and R₇ is an organic group having an unsaturated aliphatic hydrocarbon group, L₁ and L₂ are each independently an amino group, an acid anhydride group, an isocyanate group, a carboxy group, an acid ester group, an acid halide group, a hydroxy group, an epoxy group or a mercapto group, i is an integer of 1 to 200, and j and k are each independently an integer of 0 to 200, tetracarboxylic dianhydride, and diamine; and enables to have an arbitrary end group induced from these monomer units.

Acid Dianhydride

The P₂ group represented by formula (2) can be, for example, a tetravalent group induced from a fluorene backbone (residue group of acid anhydride having the fluorene backbone). As the acid anhydride having a fluorene backbone, examples thereof include 9,9-bis[4-(3,4-dicarboxyphenoxy)phenyl]fluorene dianhydride, 9,9-bis(3,4-dicarboxyphenyl)fluorene dianhydride, 9,9-bis[4-(3,4-dicarboxyphenoxy)phenyl]fluorene dianhydride, 9,9-bis[4-(3,4-dicarboxyphenoxy)-3-phenylphenyl]fluorene dianhydride, 9,9-bis[4-(2,3-dicarboxyphenoxy)-3-phenylphenyl]fluorene dianhydride, 9,9-bis[4-(3,4-dicarboxyphenoxy)-2-phenylphenyl]fluorene dianhydride, 9,9-bis[4-(2,3-dicarboxyphenoxy)-2-phenylphenyl]fluorene dianhydride, 9,9-bis[4-(3,4-dicarboxyphenoxy)-3-methylphenyl]fluorene dianhydride, 9,9-bis[4-(2,3-dicarboxyphenoxy)-3-methylphenyl]fluorene dianhydride, 9,9-bis[4-(3,4-dicarboxyphenoxy)-2-methylphenyl]fluorene dianhydride, 9,9-bis[4-(2,3-dicarboxyphenoxy)-2-methylphenyl]fluorene dianhydride, 9,9-bis[4-(3,4-dicarboxyphenoxy)-3-ethylphenyl]fluorene dianhydride, 9,9-bis[4-(2,3)-dicarboxyphenoxy)-3-ethylphenyl]fluorene dianhydride, 9,9-bis[4-(3,4-dicarboxyphenoxy)-2-ethylphenyl]fluorene dianhydride, 9,9-bis[4-(2,3-dicarboxyphenoxy)-2-ethylphenyl]fluorene dianhydride, 9,9-bis[4-(3,4-dicarboxyphenoxy)-3-propylphenyl]fluorene dianhydride 9,9-bis[4-(2,3-dicarboxyphenoxy)-3-propylphenyl]fluorene dianhydride, 9,9-bis[4-(3,4-dicarboxyphenoxy)-2-propylphenyl]fluorene dianhydride, 9,9-bis[4-(2,3-dicarboxyphenoxy)-2-propylphenyl]fluorene dianhydride, 9,9-bis[4-(3,4-dicarboxy)phenoxy)-3-butylphenyl]fluorene dianhydride, 9,9-bis[4-(2,3-dicarboxyphenoxy)-3-butylphenyl]fluorene dianhydride, 9,9-bis[4-(3,4-dicarboxyphenoxy)-2-butylphenyl]fluorene dianhydride, 9,9-bis[4-(2,3-dicarboxyphenoxy)-2-butylphenyl]fluorene dianhydride 9,9-bis[4-(3,4-dicarboxyphenoxy)-3-t-butylphenyl]fluorene dianhydride, 9,9-bis[4-(2,3-dicarboxyphenoxy)-3-t-butylphenyl]fluorene dianhydride, 9,9-bis[4-(3,4-dicarboxyphenoxy)-2-t-butylphenyl]fluorene dianhydride, 9,9-bis[4-(2,3-dicarboxyphenoxy)-2-t-butylphenyl]fluorene dianhydride, etc. Among these aromatic bis(ether acid anhydride) compounds, the following compounds are included such as 9,9-bis[4-(3,4-dicarboxyphenoxy)phenyl]fluorene dianhydride, 9,9-bis[4-(3,4-dicarboxyphenoxy)-3-phenylphenyl]fluorene dianhydride, 9,9-bis[4-(3,4-dicarboxyphenoxy)-2-phenylphenyl]fluorene dianhydride, 9,9-bis[4-(3,4-dicarboxyphenoxy)-3-methylphenyl]fluorene dianhydride, 9,9-bis[4-(3,4-dicarboxyphenoxy)-2-methylphenyl]fluorene dianhydride, 4,4′-((9H-fluorenyl)bis(4,1-phenyleneoxycarbonyl)) diphthalic dianhydride, and acid anhydrides having a fluorene backbone represented by the following formula:

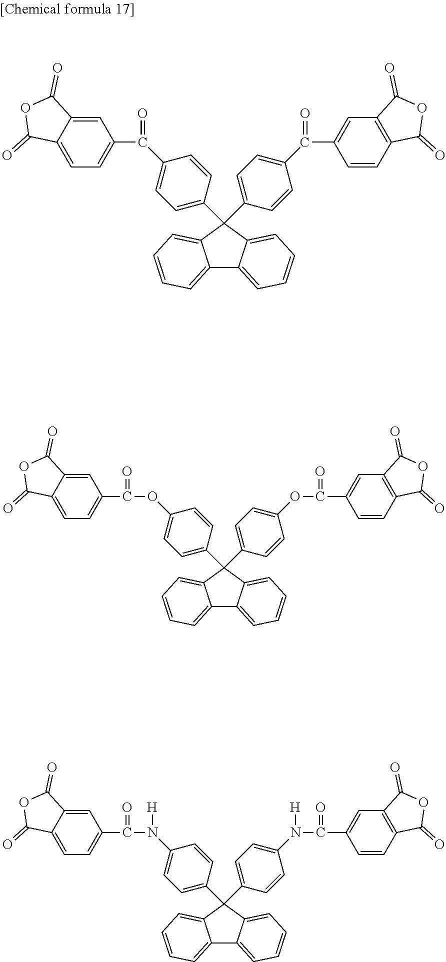 [SMILES: O=C(c1ccc(C2(c3ccc(C(=O)c4ccc5c(c4)C(=O)OC5=O)cc3)c3ccccc3-c3ccccc32)cc1)c1ccc2c(c1)C(=O)OC2=O ; O=C(Oc1ccc(C2(c3ccc(OC(=O)c4ccc5c(c4)C(=O)OC5=O)cc3)c3ccccc3-c3ccccc32)cc1)c1ccc2c(c1)C(=O)OC2=O ; O=C(Nc1ccc(C2(c3ccc(NC(=O)c4ccc5c(c4)C(=O)OC5=O)cc3)c3ccccc3-c3ccccc32)cc1)c1ccc2c(c1)C(=O)OC2=O]

Among these, 9,9-bis(3,4-dicarboxyphenyl)fluorene dianhydride or 9,9-bis[4-(3,1-, 3,2-,3,3- or 3,4-dicarboxyphenoxy)phenyl]fluorene dianhydride is preferred, and from the viewpoint of cost, 9,9-bis(3,4-dicarboxyphenyl)fluorene dianhydride (BPAF) or 9,9-bis[4-(3,4-dicarboxyphenoxy)phenyl]fluorene dianhydride (BPAF-PA) is more preferred.

The polyimide precursor represented by formula (1) preferably has a residue of acid dianhydride other than fluorene acid dianhydride in addition to the structure unit having the P₂ group represented by formula (2), from the viewpoint of reducing the haze of a film and a filamentous foreign substance attached to a coating film.

As acid dianhydride other than fluorene acid dianhydride, examples thereof include pyromellitic dianhydride, 3,3′,4,4′-biphenyltetracarboxylic dianhydride, 2,2′,3,3′-biphenyltetracarboxylic dianhydride, 4,4′-(hexafluoroisopropylidene)diphthalic anhydride (6FDA), 5-(2,5-dioxotetrahydro-3-furanyl)-3-methyl-cyclohexene-1,2-dicarboxylic anhydride, 1,2,3,4-benzenetetracarboxylic dianhydride, 3,3′,4,4′-benzophenonetetracarboxylic dianhydride, 2,2′,3,3′-benzophenonetetracarboxylic dianhydride, 3,3′,4,4′-diphenyl sulfonetetracarboxylic dianhydride (DSDA), methylene-4,4′-diphthalic dianhydride, 1,1-ethylidene-4,4′-diphthalic dianhydride, 2,2-propylidene-4,4′-diphthalic dianhydride, 1,2-ethylene-4,4′-diphthalic dianhydride, 1,3-trimethylene-4,4′-diphthalic dianhydride, 1,4-tetramethylene-4,4′-diphthalic dianhydride, 1,5-pentamethylene-4,4′-diphthalic dianhydride, 4,4′-oxydiphthalic dianhydride (ODPA), p-phenylene bis(trimellitate anhydride) (TAHQ), thio-4,4′-diphthalic dianhydride, sulfonyl-4,4′-diphthalic dianhydride, 1,3-bis(3,4-dicarboxyphenyl)benzene dianhydride, 1,3-bis(3,4-dicarboxyphenoxy)benzene dianhydride, 1,4-bis(3,4-dicarboxyphenoxy)benzene dianhydride, 1,3-bis[2-(3,4-dicarboxyphenyl)-2-propyl]benzene dianhydride, 1,4-bis[2-(3,4-dicarboxyphenyl)-2-propyl]benzene dianhydride, bis1[3-(3,4-dicarboxyphenoxy)phenyl]methane dianhydride, bis[4-(3,4-dicarboxyphenoxy)phenyl]methane dianhydride, 2,2-bis[3-(3,4-dicarboxyphenoxy)phenyl]propane dianhydride, 2,2-bis [4-(3,4-dicarboxyphenoxy)phenyl]propane dianhydride, bis(3,4-dicarboxyphenoxy)dimethylsilane dianhydride, 1,3-bis(3,4-dicarboxyphenyl)-1,1,3,3-tetramethyldisiloxane dianhydride, 2,3,6,7-naphthalenetetracarboxylic dianhydride, 1,4,5,8-naphthalene tetracarboxylic dianhydride, 1,2,5,6-naphthalene tetracarboxylic dianhydride, 3,4,9,10-perylene tetracarboxylic dianhydride, 2,3,6,7-anthracenetetracarboxylic dianhydride, cyclobutane tetracarboxylic dianhydrides (for example, 1,2,3,4-cyclobutane tetracarboxylic dianhydride, 1,2,3,4-tetramethyl-1,2,3,4-cyclobutanetetracarboxylic dianhydride, etc.), cyclohexane tetracarboxylic dianhydrides (for example, 1,2,4,5-cyclohexanetetracarboxylic dianhydride, etc.), norbornane-2-spiro-α-cyclopentanone-α′-spiro-2″-norbornane-5,5″,6,6″-tetracarboxylic dianhydride (CpODA), 1,2,7,8-phenanthrene tetracarboxylic dianhydride, etc. Among these, from the viewpoint of reducing haze and the filamentous foreign substances, at least one compound selected from the group consisting of pyromellitic dianhydride, 3,3′,4,4′-biphenyltetracarboxylic dianhydride, 4,4′-oxydiphthalic anhydride, cyclohexane tetracarboxylic dianhydride, cyclobutane tetracarboxylic dianhydride, 4,4′-(hexafluoroisopropylidene)diphthalic anhydride (6FDA), norbornane-2-spiro-α-cyclopentanone-α′-spiro-2″-norbornane-5,5″,6,6″-tetracarboxylic dianhydride (CpODA), P-phenylenebis(trimellitate anhydride) (TAHQ), and 3,3′,4,4′-diphenylsulfone tetracarboxylic dianhydride (DSDA), is more preferred, with at least one of pyromellitic dianhydride and 3,3′,4,4′-biphenyltetracarboxylic dianhydride being more preferred.

The content of acid dianhydride induced from the fluorene backbone in all acid the dianhydrides that are used as raw materials of the polyimide precursor is preferably 20% by mole or more, more preferably 50% by mole or more, and still more preferably 80% by mole or more, from the viewpoint of the low Rth of a polyimide film and adhesion between a support and the polyimide film.

Diamine

As the diamine containing the P₁ group in formula (1), examples thereof include diaminodiphenyl sulfones (for example, 4,4′-diaminodiphenyl sulfone, 3,3′-diaminodiphenyl sulfone), p-phenylenediamine, m-phenylenediamine, 4,4′-diaminodiphenyl sulfide, 3,4′-diaminodiphenyl sulfide, 3,3′-diaminodiphenyl sulfide, 4,4′-diaminobiphenyl, 3,4′-diaminobiphenyl, 3,3′-diaminobiphenyl, 2,2′-bis(trifluoromethyl)benzidine (alias: 4,4′-diamino-2,2′-bis(trifluoromethyl)biphenyl), m-tolidine (alias: 4,4′-diamino-2,2′-dimethylbiphenyl), 4,4′-diaminobenzophenone, 3,4′-diaminobenzophenone, 3,3′-diaminobenzophenone, 4,4′-diaminodiphenylmethane, 3,4′-diaminodiphenylmethane, 3,3′-diaminodiphenylmethane, 1,4-bis(4-aminophenoxy)benzene, 1,3-bis(4-aminophenoxy)benzene, 1,3-bis(3-aminophenoxy)benzene, bis[4-(4-aminophenoxy)phenyl]sulfone, 4,4-bis(4-aminophenoxy)biphenyl, 4,4-bis(3-aminophenoxy)biphenyl, bis[4-(4-aminophenoxy)phenyl]ether, bis[4-(3-aminophenoxy)phenyl]ether, 1,4-bis(4-aminophenyl)benzene, 1,3-bis(4-aminophenyl)benzene, 9,10-bis(4-aminophenyl)anthracene, 2,2-bis(4-aminophenyl)propane, 2,2-bis(4-aminophenyl)hexafluoropropane, 2,2-bis[4-(4-aminophenoxy)phenyl]propane, 2,2-bis[4-(4-aminophenoxy)phenyl]hexafluoropropane, 9,9-bis(4-aminophenyl)fluorene, cyclohexanediamine (for example, 1,4-diaminocyclohexane, 1,2-diaminocyclohexane, and a cis- or trans-isomer thereof or mixture of cis-isomer and trans-isomer, etc.), 4,4′-diaminodicyclohexylmethane (for example, product name “WONDAMINE” manufactured by New Japan Chemical Co., Ltd., etc.), 1,4-bis(3-aminopropyldimethylsilyl)benzene, etc. The diamines can be used singly or two or more may be used in combination. Diaminodiphenyl sulfone is preferably copolymerized with other diamines.

Among these, from the viewpoint of securing film transparency and reducing the Rth, YI value and haze of the film, at least one selected from the group consisting of 2,2′-diaminobis(trifluoromethyl)biphenyl, 4,4′- and/or 3,3′-diaminodiphenyl sulfone, 9,9-bis(4-aminophenyl)fluorene and 1,4-diaminocyclohexane, is preferred. In addition, the diamine containing the P₁ group in formula (1) preferably includes diaminodiphenyl sulfone (DAS), such as 4,4′-diaminodiphenyl sulfone, and/or 3,3′-diaminodiphenyl sulfone.

Among all the diamines, the content of each diamine of the aforementioned 2,2′-diaminobis(trifluoromethyl)biphenyl, 4,4′- and/or 3,3′-diaminodiphenyl sulfone, 9,9-bis(4-aminophenyl)fluorene, and 1,4-diaminocyclohexane, may be 50% by mole or more, or 70% by mole or more, or 90% by mole or more, or 95% by mole or more. As the amount of diaminodiphenyl sulfone and/or each of the aforementioned diamines is larger, it is preferable because the transparency is secured, and Rth, YI value, etc., of the polyimide film are reduced. As diaminodiphenyl sulfone, 4,4′-diaminodiphenyl sulfone is particularly preferable from the viewpoint of reducing the YI value.

Structure Unit Represented by Formula (3)

The polyimide precursor according to the present embodiment has a structure unit represented by formula (3). The lower limit of the proportion of the structure portion represented by formula (3) is preferably 5% by weight or more, more preferably 6% by weight or more, and furthermore preferably 7% by weight or more based on the weight of the polyimide precursor, from the viewpoint of reducing the residual stress of the polyimide film, generated with the support. The upper limit of the proportion of the structure portion represented by formula (2) is preferably 40% by weight or less, more preferably 30% by weight or less, and still more preferably 25% by weight or less based on the weight of the polyimide precursor, from the viewpoint of the transparency and heat resistance of the polyimide film.

In the aforementioned formula (3), q is a positive integer, preferably 1 to 200, and more preferably 3 to 200, from the viewpoint of the heat resistance of the resulting polyimide.

The polyimide precursor may have the structure unit represented by formula (3) at any position in the molecule, but from the viewpoint of the type of siloxane monomer, cost and molecular weight of the polyimide precursor obtained, the structure represented by formula (3) is preferably derived from a silicon-containing compound such as silicon-containing diamine. As the silicon-containing diamine, for example, diamino (poly)siloxane represented by the following formula (6):

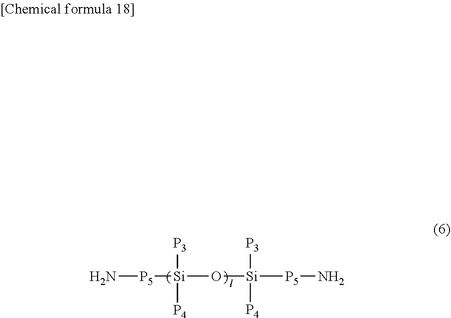

wherein, P₅ each independently represents a divalent hydrocarbon group, which may be the same or different, P₃ and P₄ are the same as those defined in formula (2), and 1 is an integer of 1 to 200, is preferred.

As a preferable structure of P₅ in formula (6), a methylene group, ethylene group, propylene group, butylene group, phenylene group, etc., are included. Moreover, as a preferable structure of P₃ and P₄, a methyl group, ethyl group, propyl group, butyl group, phenyl group, etc., are included. In formula (6), 1 is an integer of 1 to 200, and it is preferably an integer of 3 to 200 from the viewpoint of the heat resistance of the polyimide obtained using the compound represented by formula (6).

The number-average molecular weight (=functional group equivalent×2) of the compound represented by formula (6) is preferably 500 or more, more preferably 1,000 or more, and further preferably 2,000 or more from the viewpoint of reducing the residual stress generated between the obtained polyimide film and the support. The number-average molecular weight is preferably 12,000 or less, more preferably 10,000 or less, and still more preferably 8,000 or less from the viewpoint of the transparency (particularly low haze) of the polyimide film obtained.

As the compound represented by formula (6), specific examples thereof include a both amine end-modified methylphenyl silicone oil (X22-1660B-3 (number-average molecular weight of 4400) manufactured by Shin-Etsu Chemical Co., Ltd., X22-9409 (number-average molecular weight of 1300), both amine end-modified dimethyl silicone (X-22-161A (number-average molecular weight of 1600) manufactured by Shin-Etsu Chemical Co., Ltd., X22-161B (number-average molecular weight of 3000), KF-8012 (number-average molecular weight of 4400), 8008, 8012 manufactured by Dow Corning Toray Co., Ltd; BY16-835U (number-average molecular weight of 900) manufactured by Chisso Corporation; Silaplane FM3311 (number-average molecular weight of 1000), etc. Among these, from the viewpoint of improving chemical resistance and Tg, the both amine end-modified methylphenyl silicone oil is preferred.

The copolymerization ratio of the silicon-containing diamine is preferably 0.5 to 30% by weight, more preferably 1.0% by weight to 25% by weight, and still more preferably 1.5% by weight to 20% by weight, based on a total weight of the polyimide precursor. When the silicon-containing diamine is 0.5% by weight or more, the residual stress generated with the support can be effectively reduced. Moreover, when the silicon-containing diamine is 30% by weight or less, the transparency (particularly low HAZE) of the obtained polyimide film is favorable, and it is preferable from the viewpoint of achieving high total light transmittance and high glass transition temperature.

Dicarboxylic Acid

As an acid component for forming the polyimide precursor in the present embodiment, in addition to the acid dianhydride (for example, the tetracarboxylic dianhydride listed above), dicarboxylic acid may be used within a range that does not impair the performance thereof. Namely, the polyimide precursor in the present embodiment may be a polyamideimide precursor. A film obtained from such a polyamideimide precursor may have favorable properties such as mechanical elongation, glass transition temperature Tg, YI value, etc. As the dicarboxylic acid to be used, dicarboxylic acid having an aromatic ring and alicyclic dicarboxylic acid are included. In particular at least one compound selected from the group consisting of aromatic dicarboxylic acid having 8 to 36 carbon atoms and alicyclic dicarboxylic acid having 6 to 34 carbon atoms, is preferred. The number of carbon atoms referred to herein includes the number of carbon atoms contained in the carboxy group. Among these, dicarboxylic acid having an aromatic ring is preferred.

As the dicarboxylic acid having an aromatic ring, examples thereof include isophthalic acid, terephthalic acid, 4,4′-biphenyldicarboxylic acid, 3,4′-biphenyldicarboxylic acid, 3,3′-biphenyldicarboxylic acid, 1,4-naphthalenedicarboxylic acid, 2,3-naphthalenedicarboxylic acid, 1,5-naphthalenedicarboxylic acid, 2,6-naphthalenedicarboxylic acid, 4,4′-sulfonylbisbenzoic acid, 3,4′-sulfonylbisbenzoic acid, 3,3′-sulfonylbisbenzoic acid, 4,4′-oxybisbenzoic acid, 3,4′-oxybisbenzoic acid, 3,3′-oxybisbenzoic acid, 2,2-bis(4-carboxyphenyl)propane, 2,2-bis(3-carboxyphenyl)propane, 2,2′-dimethyl-4,4′-biphenyldicarboxylic acid, 3,3′-dimethyl-4,4′-biphenyldicarboxylic acid, 2,2′-dimethyl-3,3′-biphenyldicarboxylic acid, 9,9-bis(4-(4-carboxyphenoxy)phenyl)fluorene, 9,9-bis(4-(3-carboxyphenoxy)phenyl)fluorene, 4,4′-bis(4-carboxyphenoxy)biphenyl, 4,4′-bis(3-carboxyphenoxy)biphenyl, 3,4′-bis(4-carboxyphenoxy)biphenyl, 3,4′-bis(3-carboxyphenoxy)biphenyl, 3,3′-bis(4-carboxyphenoxy)biphenyl, 3,3′-bis(3-carboxyphenoxy)biphenyl, 4,4′-bis(4-carboxyphenoxy)-p-terphenyl, 4,4′-bis(4-carboxyphenoxy)-m-terphenyl, 3,4′-bis(4-carboxyphenoxy)-p-terphenyl, 3,3′-bis(4-carboxyphenoxy)-p-terphenyl, 3,4′-bis(4-carboxyphenoxy)-m-terphenyl, 3,3′-bis(4-carboxyphenoxy)-m-terphenyl, 4,4′-bis(3-carboxyphenoxy)-p-terphenyl, 4,4′-bis(3-carboxyphenoxy)-m-terphenyl, 3,4′-bis(3-carboxyphenoxy)-p-terphenyl, 3,3′-bis(3-carboxyphenoxy)-p-terphenyl, 3,4′-bis (3-carboxyphenoxy)-m-terphenyl, 3,3′-bis(3-carboxyphenoxy)-m-terphenyl, 1,1-cyclobutanedicarboxylic acid, 1,4-cyclohexanedicarboxylic acid, 1,2-cyclohexanedicarboxylic acid, 4,4′-benzophenonedicarboxylic acid, 1,3-phenylenediacetic acid, 1,4-phenylenediacetic acid, etc.; 5-aminoisophthalic acid derivatives described in WO2005/068535, etc. When these dicarboxylic acids are actually copolymerized into a polymer, these may be used in the form of an acid chloride compound formed using thionyl chloride, etc., and active ester compound, etc.

Silicon-Containing Compound Represented by Formula (5)

The polyimide precursor represented by formula (1) is, as described above, preferably a copolymer containing as monomer units the silicon-containing compound represented by formula (5), tetracarboxylic acid anhydride and diamine.

L₁ and L₂ of the silicon-containing compound represented by formula (5) are each independently an amino group, acid anhydride group, isocyanate group, carboxy group, acid ester group, acid halide group, hydroxy group, epoxy group, or mercapto group, and an amino group or acid anhydride group is preferable from the viewpoint of the molecular weight of the resulting polyimide precursor, an amino group is more preferable from the viewpoint of the molecular weight of the polyimide precursor.

In formula (5), R₁ each independently represents, single bond or a divalent organic group of 1 to 10 carbon atoms. The divalent organic group of 1 to 10 carbon atoms may be linear, cyclic or branched, and may be saturated or unsaturated. Examples of the divalent aliphatic hydrocarbon group of 1 to 10 carbon atoms include linear or branched alkylene chains such as methylene, ethylene, n-propylene, i-propylene, n-butylene, s-butylene, t-butylene, n-pentylene, neopentylene, n-hexylene, n-heptylene, n-octylene, n-nonylene, n-decylene group, etc.; and cycloalkylene groups such as cyclopropylene, cyclobutylene, cyclopentylene, cyclohexylene, cycloheptylene, cyclooctylene group, etc. As the divalent aliphatic hydrocarbon group of 1 to 10 carbon atoms, at least one selected from the group consisting of ethylene, n-propylene and i-propylene is preferred.

In formula (5), R₂ and R₃ are each independently a monovalent organic group having 1 to 10 carbon atoms, and at least one thereof is a monovalent aliphatic hydrocarbon group having 1 to 5 carbon atoms. The monovalent organic group having 1 to 10 carbon atoms may be linear, cyclic or branched, and may be saturated or unsaturated. As the monovalent organic group having 1 to 10 carbon atoms, examples thereof include linear or branched alkyl groups, such as methyl, ethyl, n-propyl, i-propyl, n-butyl, s-butyl, t-butyl, n-pentyl, neopentyl, n-hexyl, n-heptyl, n-octyl, n-nonyl, n-decyl group, etc.; cycloalkyl groups such as cyclopropyl, cyclobutyl, cyclopentyl, cyclohexyl, cycloheptyl, cyclooctyl group, etc., and aromatic groups such as phenyl, tolyl, xylyl, α-naphthyl, β-naphthyl group, etc. The monovalent aliphatic hydrocarbon group having 1 to 5 carbon atoms may be linear, cyclic or branched, and may be saturated or unsaturated. As the monovalent aliphatic hydrocarbon group having 1 to 5 carbon atoms, examples thereof include linear or branched alkyl groups such as methyl, ethyl, n-propyl, i-propyl, n-butyl, s-butyl, t-butyl, n-pentyl, neopentyl group, etc.; and cycloalkyl groups such as cyclopropyl, cyclobutyl, cyclopentyl group, etc. As the monovalent aliphatic hydrocarbon group having 1 to 5 carbon atoms, at least one selected from the group consisting of methyl, ethyl and n-propyl is preferred.

In formula (5), R₄ and R₅ are each independently a monovalent organic group having 1 to 10 carbon atoms, and at least one is a monovalent aromatic group having 6 to 10 carbon atoms. The monovalent organic group having 1 to 10 carbon atoms may be linear, cyclic or branched, and may be saturated or unsaturated. As the monovalent organic group having 1 to 10 carbon atoms, examples thereof include linear or branched alkyl groups such as methyl, ethyl, n-propyl, i-propyl, n-butyl, s-butyl, t-butyl, n-pentyl, neopentyl, n-hexyl, n-heptyl, n-octyl, n-nonyl, n-decyl group, etc.; cycloalkyl groups such as cyclopropyl, cyclobutyl, cyclopentyl, cyclohexyl, cycloheptyl, cyclooctyl group, etc., and aromatic groups such as phenyl, tolyl, xylyl, α-naphthyl, β-naphthyl group, etc. Examples of the monovalent aromatic group having 6 to 10 carbon atoms include phenyl, tolyl, xylyl, α-naphthyl, β-naphthyl group, etc., with phenyl, tolyl or xylyl being preferred.

In formula (5), R₆ and R₇ are each independently a monovalent organic group of 1 to 10 carbon atoms, and at least one is an organic group having an unsaturated aliphatic hydrocarbon group. The monovalent organic group of 1 to 10 carbon atoms may be linear, cyclic or branched, and examples thereof include linear or branched alkyl groups such as methyl, ethyl, n-propyl, i-propyl, n-butyl and s-butyl, t-butyl, n-pentyl, neopentyl, n-hexyl, n-heptyl, n-octyl, n-nonyl, n-decyl group, etc.; cycloalkyl groups such as cyclopropyl, cyclobutyl, cyclopentyl, cyclohexyl, cycloheptyl, cyclooctyl group, etc.; and aromatic groups such as phenyl, tolyl, xylyl, α-naphthyl, β-naphthyl group, etc. As the monovalent organic group of 1 to 10 carbon atoms, at least one selected from the group consisting of methyl, ethyl and phenyl is preferred. The organic group having an unsaturated aliphatic hydrocarbon group may be an unsaturated aliphatic hydrocarbon group of 3 to 10 carbon atoms, and may be linear, cyclic or branched. Examples of the unsaturated aliphatic hydrocarbon group of 3 to 10 carbon atoms include vinyl, allyl, propenyl, 3-butenyl, 2-butenyl, pentenyl, cyclopentenyl, hexenyl, cyclohexenyl, heptenyl, octenyl, nonenyl, decenyl, ethynyl, propynyl, butynyl, pentynyl, hexynyl group, etc. The unsaturated aliphatic hydrocarbon group of 3 to 10 carbon atoms is preferably at least one selected from the group consisting of vinyl, allyl and 3-butenyl.

In formula (5), the hydrogen atoms of R₁ to R₇ may be partially or totally substituted by a substituent such as a halogen atom including F, Cl or Br, etc., or may be unsubstituted.

The subscript i is an integer of 1 to 200, preferably an integer of 2 to 100, more preferably an integer of 4 to 80, and still more preferably an integer of 8 to 40. The subscripts j and k are each independently an integer of 0 to 200, preferably an integer of 0 to 50, more preferably an integer of 0 to 20, and still more preferably an integer of 0 to 50.

In the copolymer, the tetracarboxylic dianhydride and the diamine contained as monomer units together with the silicon-containing compound represented by formula (5) may be the tetracarboxylic dianhydride and the diamine listed in regard to formula (1), respectively.

[Resin Composition]

The resin composition according to the present embodiment comprises the polyimide precursor explained above and a solvent. The solvent is not restricted, however, the following solvents may be included:

Amide-based solvents such as N-methyl-2-pyrrolidone (NMP), N-ethyl-2-pyrrolidone (NEP), N,N-dimethylacetamide (DMAc), 1,3-dimethylimidazolidinone, tetramethylurea, N,N-dimethylpropionamide, N,N-diethylacetamide, β-alkoxypropionamide, N,N-dimethylformamide, N-methyl-ε-caprolactam, and the amide-based compound represented by the following formula (10):

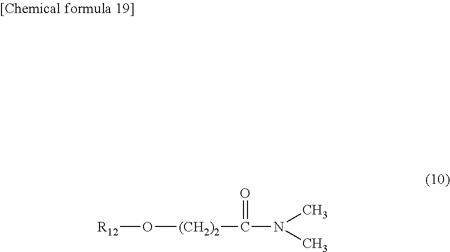

wherein, R₁₂ is an alkyl group, and for example, Equamide M100 (trade name) provided R₁₂=a methyl group, manufactured by Idemitsu Kosan Co., Ltd. and Equamide B100 (trade name) provided R₁₂=n-butyl group, manufactured by Idemitsu Kosan Co., Ltd., may be used.

Non-amide-based solvents such as tetrahydrofuran (THF), acetonitrile, propylene glycol monomethyl ether (PGME), propylene glycol monomethyl ether acetate (PGMEA), ethyl lactate, cyclopentanone, amyl acetate, ethylene glycol monoethyl ether, propylene glycol monomethyl ether acetate, etc.

The solvents explained above may be used singly or in combination thereof.

The solid content of a resin composition comprising the polyimide precursor is preferably 9 to 25% by weight, more preferably 9 to 20% by weight, still more preferably 9 to 15% by weight, and even more preferably 9 to 13% by weight, from the viewpoint of the coating properties in slit coating, such as suppressing liquid leakage from a slit nozzle and liquid drip of the coating film, which enables to secure an appropriate coater gap and to provide the polyimide precursor or polyimide film excellent in productivity.

The “solid content” in the present description is all components other than the solvent in the resin composition, and a liquid monomer component is also included in a weight of the solid content. When the resin composition comprises only the solvent and the polyimide precursor, the polyimide precursor corresponds to the solid content, and accordingly, the solid content weight corresponds to the total weight of all the monomers comprised in the polyimide precursor. The solid content weight can also be determined by subtracting the weight of the solvent from the weight of the resin composition after determining the weight of the solvent by gas chromatography (hereinafter also referred to as GC) analysis of the resin composition.

<Cyclic Siloxane Amount>

The resin composition comprises the cyclic siloxane compound represented by the following formula (4) in a specific amount:

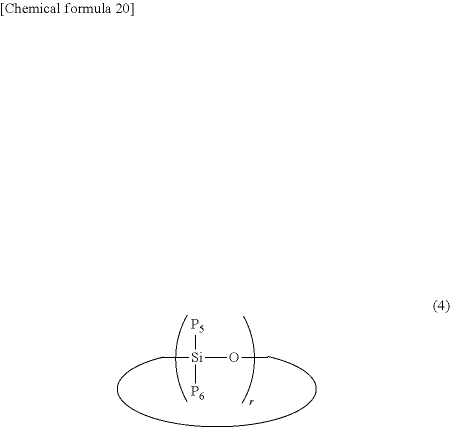

wherein, P₅ and P₆ are each independently a monovalent aliphatic hydrocarbon group of 1 to 5 carbon atoms or an aromatic group of 6 to 10 carbon atoms, r is an integer of 3 or more, and preferably an integer of 3 to 8.

The amount of the cyclic siloxane represented by formula (4) in the present description may be specifically a total amount of the compounds wherein r=3 to 8 in formula (4).

The amount of the compound represented by formula (4) is preferably greater than 0 ppm and 300 ppm or less, more preferably greater than 0 ppm and 70 ppm or less, and still more preferably greater than 0 ppm and 45 ppm or less based on the weight of the resin composition. If the amount of the compound represented by formula (4) is within the aforementioned range, it is preferable from the viewpoint of the YI of the obtained polyimide film and from the standpoint of reducing a total number of foreign substances adhering to the polyimide resin film in a manufacturing process of the polyimide resin film.

The amount of the compound represented by formula (4) is preferably greater than 0 ppm and 1500 ppm or less, more preferably greater than 0 ppm and 500 ppm or less, and still more preferably greater than 0 ppm and 100 ppm or less based on the solid content weight of the resin composition. If the amount of the compound represented by formula (4) is within the aforementioned range, it is preferable from the viewpoint of the YI of the obtained polyimide film and from the standpoint of reducing a total number of foreign substances adhering to the polyimide resin film in the manufacturing process of the polyimide resin film.

The amount of the compound represented by formula (4) is preferably greater than 0 ppm and 450 ppm or less, more preferably greater than 0 ppm and 150 ppm or less, and still more preferably greater than 0 ppm and 10 ppm or less when a total amount of the silicon-containing compounds represented by formulas (4) and (5) is 100 parts. If the amount of the compound represented by formula (4) is within the aforementioned range, it is preferable from the viewpoint of the YI of the obtained polyimide film and from the standpoint of reducing a total number of foreign substances adhering to the polyimide resin film in the manufacturing process of the polyimide resin film.

<Additional Component>

The resin composition of the present embodiment may further comprise, in addition to the components explained above, additional components such as a surfactant, alkoxysilane compound, etc.

[Resin Composition Manufacturing Method]

The method for manufacturing the resin composition in the present embodiment is not specifically restricted, and for example, it can be produced based on the following method.

<Adjustment of Content of Silicon-Containing Compound>

The resin composition of the present embodiment can be produced by subjecting polycondensation components including the acid dianhydride, the diamine, and the silicon-containing compound to a polycondensation reaction. As a method for adjusting a total amount of the compounds represented by formula (4) comprised in the resin composition of this embodiment, a method such as purifying the silicon-containing compound prior to the polycondensation reaction to control the total amount of the compound represented by formula (4), is included. Alternatively, after the polycondensation reaction, the resin composition may be purified to control the total amount of the compound represented by formula (4). In any case, the total amount of the compound represented by formula (4) in the polyimide precursor composition is adjusted to be greater than 0 ppm.

As a purification method of the silicon-containing compound, an example thereof includes such as carrying out stripping while blowing an inert gas such as nitrogen gas into the silicon-containing compound in an arbitrary container. The temperature for stripping is preferably 150° C. or higher and 300° C. or lower, more preferably 160° C. or higher and 300° C. or lower, and still more preferably 200° C. or higher and 300° C. or lower. The vapor pressure of stripping is preferably as low as possible, and it is 1000 Pa or lower, more preferably 300 Pa or lower, still more preferably 200 Pa or less, and furthermore preferably 133.32 Pa (1 mmHg) or lower. The stripping time is preferably 2 hours or longer and 12 hours or shorter, more preferably 4 hours or longer and 12 hours or shorter, and still more preferably 6 hours or longer and 10 hours or shorter. By adjusting to the aforementioned conditions, the total amount of the compounds represented by formula (4) can be controlled in a preferable range. In the step of reducing the amount of the compounds represented by formula (4) contained in the silicon-containing compound represented by formula (5), it is also preferable to subject the resin composition to stripping treatment under the conditions of 150° C. to 300° C. and 1000 Pa or lower for 2 hours to 12 hours.

### <Synthesis of Polyimide Precursor>

The polyimide precursor of this embodiment can be synthesized by subjecting polycondensation components comprising the acid dianhydride, diamine, and silicon-containing compound to a polycondensation reaction. As the silicon-containing compound, it is preferable to use the aforementioned purified one. In a preferred aspect, the polycondensation components consist of the acid dianhydride, diamine and silicon-containing compound. The polycondensation reaction is preferably carried out in a suitable solvent. Specifically, for example, a method for dissolving a prescribed amount of the diamine component and the silicon-containing compound in a solvent, followed by adding a prescribed amount of the acid dianhydride to the obtained diamine solution with stirring, is included.

The molar ratio of the acid dianhydride and the diamine when synthesizing the polyimide precursor is, from the viewpoint of increasing the molecular weight of the polyimide precursor resin and the slit coating characteristics of the resin composition, the ratio of acid dianhydride:diamine is 100:90 to 100:110 (0.90 to 1.10 mole parts of the diamine with respect to 1 mole part of the acid dianhydride) is preferred, and the ratio of 100:95 to 100:105 (0.95 to 1.05 mole parts of the diamine per 1 mole part of the acid dianhydride) is more preferred.

The molecular weight of the polyimide precursor can be controlled by the types of acid the dianhydride, diamine and silicon-containing compound, adjustment of the molar ratio between the acid dianhydride and the diamine, addition of an end capping agent, adjustment of reaction conditions, etc. The polyimide precursor can be highly polymerized as the molar ratio of acid dianhydride component:diamine component is closer to 1:1 and as the use amount of the end capping agent is smaller.

It is recommended to use a high purity product as the acid dianhydride component and the diamine component. The purity thereof is each preferably 98% by weight or higher, more preferably 99% by weight or higher, and still more preferably 99.5% by weight or higher. Purification can also be achieved by reducing a water content of the acid dianhydride component and diamine component. When a plurality of acid dianhydride components and/or a plurality of diamine components are used, it is preferred to attain the aforementioned purity as the whole acid dianhydride components and the whole diamine components, and more preferably each of all the types of the acid dianhydride components and the diamine components to be used has the aforementioned purity.

In the present embodiment, the solvent for the reaction is basically used as the solvent contained in the resin composition.

Moreover, in another aspect, a solvent that enables to dissolve the acid dianhydride component, the diamine component and the resulting polyimide precursor, and to provide a polymer having a high molecular weight, can be used. Examples of such a solvent include an aprotic solvent, phenol-based solvent, ether-based or glycol-based solvent, etc.

As the aprotic solvent, examples thereof include the following solvents:
Amide-based solvents such as N, N-dimethylformamide (DMF), N, N-dimethylacetamide (DMAc), N-methyl-2-pyrrolidone (NMP), N-methylcaprolactam, 1,3-dimethylimidazolidinone, tetramethylurea, the amide-based compound represented by the above formula (5), etc.;
Lactone-based solvents such as γ-butyrolactone, γ-valerolactone, etc.;
Phosphorus-containing amide-based solvents such as hexamethyl phosphoric amide, hexamethyl phosphine triamide, etc.;
Sulfur-containing solvents such as dimethyl sulfone, dimethyl sulfoxide, sulfolane, etc.;
Ketone-based solvents such as cyclohexanone, methyl cyclohexanone, etc.;
Tertiary amine-based solvents such as picolin, pyridine, etc.;
Ester-based solvents such as (2-methoxy-1-methylethyl) acetate, etc.

Examples of the phenol-based solvents include phenol, o-cresol, m-cresol, p-cresol, 2,3-xylenol, 2,4-xylenol, 2,5-xylenol, 2,6-xylenol, 3,4-xylenol, 3,5-xylenol, etc.

As ether- and glycol-based solvents, for example, 1,2-dimethoxyethane, bis(2-methoxyethyl)ether, 1,2-bis(2-methoxyethoxy)ethane, bis[2-(2-methoxyethoxy)ethyl]ether, tetrahydrofuran, 1,4-dioxane, etc., are included.

The resin composition of the present embodiment may comprise other additional polyimide precursors in addition to the polyimide precursor of the present embodiment. However, the weight ratio of the additional polyimide precursor is preferably 30% by weight or less and more preferably 10% by weight or less with respect to the total amount of the polyimide precursors in the resin composition from the viewpoint of reducing the oxygen dependency of YI value and total light transmittance of the polyimide film.

The polyimide precursor in the present embodiment may be partially imidized (partial imidization). When it is partially imidized, it is possible to improve the viscosity stability when storing the resin composition. The imidization ratio in this case is preferably 5% or more and more preferably 8% or more, preferably 80% or less, more preferably 70% or less, and further preferably 50% or less from the viewpoint of balance of the solubility of the polyimide precursor in the resin composition with the storage stability of the solution. This partial imidization is attained by heating the polyimide precursor followed by cyclodehydration thereof. This heating treatment can be carried out at a temperature of preferably 120 to 200° C., and more preferably 150 to 180° C., and can be carried out preferably for 15 minutes to 20 hours, and more preferably for 30 minutes to 10 hours.

The compound in which the carboxylic acid groups are partially or totally esterified by adding N, N-dimethylformamide dimethyl acetal or N, N-dimethylformamide diethyl acetal to the polyamic acid obtained by the above reaction followed by heating, can be used as the polyimide precursor of the present embodiment. The esterification can improve viscosity stability during storage. These ester-modified polyamic acids can also be obtained by a method for sequentially reacting the aforementioned acid dianhydride component with one equivalent of a monohydric alcohol relative to the acid anhydride group, and with a dehydration condensation agent such as thionyl chloride or dicyclohexylcarbodiimide, etc., followed by the condensation reaction with a diamine component.

<Preparation of Resin Composition>

When the solvent that is used when synthesizing the polyimide precursor and the solvent to be contained in the resin composition are different, the solvent in the solution of the synthesized polyimide precursor may be removed to isolate the polyimide precursor by an appropriate method such as reprecipitation, solvent evaporation, etc. Then, in a temperature range of room temperature (25° C.) to 80° C., the amide-based solvent, the non-amide-based solvent having a boiling point of 160° C. or higher or the silicon aggregation inhibitor, and the additional component as desired, are added to the isolated polyimide precursor followed by mixed and stirred together to prepare the resin composition according to the first or second embodiment.

After preparing the resin composition as described above, the polyimide precursor may partially be subjected to dehydration imidization (partial imidization) by heating the resin composition to such an extent that a polymer does not precipitate, for example, at 130 to 200° C., and for example, for 5 minutes to 2 hours. The imidization ratio can be controlled by setting the heating temperature and the heating time. By partial imidization of the polyimide precursor, it is possible to improve the viscosity stability when storing the resin composition.

The solution viscosity of the resin composition is preferably 500 to 100,000 mPa·s, more preferably 1,000 to 50,000 mPa·s, and still more preferably 3,000 to 20,000 mPa·s, from the viewpoint of slit coating performance. Specifically, the viscosity is preferably 500 mPa·s or higher, more preferably 1,000 mPa·s or higher, and still more preferably 3,000 mPa·s or higher, in terms of preventing liquid leakage from the slit nozzle. In addition, it is preferably 100,000 mPa·s or lower, more preferably 50,000 mPa·s or lower, and still more preferably 20,000 mPa·s or lower, in terms of suppressing nozzle clogging.

Moreover, regarding the solution viscosity of the resin composition upon polyimide precursor synthesis, when it is higher than 200,000 mPa·s, there may arise a problem of difficulty in stirring during synthesis. However, even if the solution has a high viscosity upon synthesis, it is possible to obtain a resin composition having a handleable viscosity by adding a solvent and stirring after completion of the reaction. The solution viscosity of the resin composition in the present embodiment is a value measured at 23° C. using an E-type viscometer (for example, VISCONICEHD, manufactured by Toki Sangyo Co., Ltd.).

The water content of the resin composition of the present embodiment is preferably 3,000 ppm by weight or less, more preferably 2,500 ppm by weight or less, still more preferably 2,000 ppm by weight or less, furthermore preferably 1,500 ppm by weight or less, particularly preferably 1,000 ppm by weight or less, particularly preferably 500 ppm by weight or less, particularly preferably 300 ppm by weight or less, or particularly preferably 100 ppm by weight or less, from the viewpoint of viscosity stability when storing the resin composition.

[Polyimide Film and Manufacturing Method Thereof]

A polyimide film (hereinafter, also referred to as a polyimide resin film) can be provided using the resin composition of the present embodiment. The polyimide resin film can be a cured product of the polyimide precursor as was explained above, and it is preferably used for a flexible substrate, and more preferably for a flexible display.

The method for manufacturing the polyimide film according to the present embodiment comprises the following steps:
a coating step of coating a surface of a support with the resin composition of the present embodiment;
a film forming step of forming a polyimide resin film by heating the resin composition;
an irradiation step of irradiating a laser to the resin composition from the support side if desired; and
a stripping step of stripping the polyimide resin film from the support.

<Coating Step>

In the coating step, a surface of a support is coated with the resin composition of the present embodiment. The support is not particularly limited provided that it has heat resistance for the heating temperatures in the subsequent film forming step (heating step) and exhibits a favorable stripping property in the stripping step. As the support, examples thereof include a glass substrate, for example, an alkali-free glass substrate; a silicon wafer; resin substrates such as PET (polyethylene terephthalate), OPP (oriented polypropylene), polyethylene glycol terephthalate, polyethylene glycol naphthalate, polycarbonate, polyimide, polyamideimide, polyether imide, polyether ether ketone, polyether sulfone, polyphenylene sulfone, polyphenylene sulfide, etc.; metal substrates such as stainless steel, alumina, copper, nickel, etc.

When forming a thin polyimide film, for example, a glass substrate, silicon wafer, etc., are preferred, and when forming a thick polyimide film or polyimide sheet, for example, PET (polyethylene terephthalate), OPP (oriented polypropylene), etc., are preferred.

Coating methods generally include coating means such as a doctor blade knife coater, air knife coater, roll coater, rotary coater, flow coater, die coater, bar coater, etc., coating methods such as spin coating, spray coating, dip coating, etc., and printing techniques as representative of screen printing, gravure printing, etc.

Among these, coating by slit coating is preferable for the resin composition of the present embodiment. The coating thickness ought to be appropriately adjusted according to the desired thickness of the resin film and the content of the polyimide precursor in the resin composition, and it is preferably about 1 to 1,000 m. The temperature in the coating step may be room temperature, and the resin composition may be heated, for example, to 40 to 80° C. to lower the viscosity and improve the workability.

<Optional Drying Process>

A drying process may be carried out following the coating process, or the drying process may be omitted and directly proceed to the next film forming process (heating process). The drying step can be carried out by allowing the resin composition to stand under the condition of vacuum of 100 Pa or less for the purpose of removing the organic solvent in the resin composition. When carrying out the drying, for example, appropriate devices such as a hot plate, box dryer, conveyor dryer, etc., can be used. The temperature of the drying step is preferably 80 to 200° C. and more preferably 100 to 150° C. The implementation time of the drying step is preferably 1 minute to 10 hours and more preferably 3 minutes to 5 hours. As in the manner described above, the coating film containing the polyimide precursor is formed on a support.

<Film Forming Process>

Subsequently, a film forming step (heating step) is carried out. The heating step is, in addition to a step of removing the organic solvent contained in the aforementioned coating film, a step of proceeding the imidization reaction of the polyimide precursor in the coating film to obtain a polyimide resin film. This heating step can be carried out by allowing the resin composition to stand under the vacuum of 100 Pa or less using an apparatus such as an inert gas oven, hot plate, box dryer, conveyor dryer, etc. This step may be carried out simultaneously with the drying step, or both steps may be carried out sequentially.

The heating step may be carried out in an air atmosphere, but from the viewpoint of safety, favorable transparency of the obtained polyimide film, low retardation (Rth) in thickness direction and low YI value of the polyimide film, it is preferably carried out under an inert gas atmosphere. Examples of the inert gas include nitrogen, argon, etc. The heating temperature may be appropriately set depending on a type of the polyimide precursor and a type of solvent in the resin composition, but is preferably 250° C. to 550° C. and more preferably 300 to 450° C. If the temperature is 250° C. or higher, the imidization reaction favorably proceeds, and if the temperature is 550° C. or lower, inconveniences such as decrease in transparency of the obtained polyimide film and deterioration of heat resistance, etc., can be avoided. The heating time is preferably about 0.1 to 10 hours.

In the present embodiment, the oxygen concentration in the ambient atmosphere in the above heating step is preferably 2,000 ppm by weight or less, more preferably 100 ppm by weight or less, and still more preferably 10 ppm by weight or less from the viewpoint of the transparency and YI value of the obtained polyimide film. By heating in an atmosphere with an oxygen concentration of 2,000 ppm by weight or less, the YI value of the obtained polyimide film can be 30 or less.

<Stripping Step>

In the striping step, the polyimide resin film on a support is stripped, for example, after being cooled to about room temperature (25° C.) to 50° C. Specifically, the stripping step is carried out by any one of the following methods (i) to (iii).
(i) A method for forming a stripping layer on a support before coating a surface of the support with the resin composition, obtaining a constituent comprising the polyimide resin film/stripping layer/support, and then stripping off the polyimide resin film.

The stripping layer may be, for example, parylene (registered trademark, manufactured by Parylene Japan K.K) or tungsten oxide, and releasing agents such as a vegetable oil-based, silicone-based, fluorine-based or alkyd-based agent, etc., may be used (see, for example, Japanese Unexamined Patent Publication No. 2010-067957, Japanese Unexamined Patent Publication No. 2013-179306, etc.).
(ii) A method for obtaining a constituent comprising the polyimide resin film/support using a metal substrate that can be etched as a support, followed by etching the metal with an etchant to obtain the polyimide resin film.

As the metal, for example, copper (as a specific example, electrolytic copper foil “DFF” manufactured by Mitsui Mining & Smelting Co., Ltd.), aluminum, etc., can be used. As the etchant, ferric chloride, etc., can be used for copper, and dilute hydrochloric acid, etc., can be used for aluminum.

In the method (ii), when using copper as a support, the YI value of the obtained polyimide resin film tends to be large and the elongation tends to be small. This is considered to be the effect of copper ions.
(iii) A method for obtaining a constituent comprising the polyimide resin film/support, attaching an adhesive film on the surface of the polyimide resin film, and separating the adhesive film/the polyimide resin film from the support followed by separation of the polyimide resin film from the adhesive film.

<Irradiation Step>

Moreover, from a standpoint of difference in a refractive index of the front and back of the polyimide resin film obtained, YI value, and elongation, it is preferable to carry out the irradiation step of irradiating a laser to the resin composition from the support side prior to this stripping step. Specifically, the irradiation step can be carried out as follows.

A method for preparing a constituent comprising the polyimide resin film/support by the aforementioned method, irradiating a laser from the support side of the constituent for ablation processing of the interface between the support and the polyimide resin film to strip off the polyimide resin. The type of the laser includes a solid (YAG) laser, a gas (UV excimer) laser, etc. It is preferable to use a spectrum such as a wavelength of 308 nm, etc., (see, for example, Japanese Translation of PCT International Application Publication No. JP-T-2007-512568, Japanese Translation of PCT International Application Publication No. JP-T-2012-511173, etc.).

In addition, this irradiation step can be combined for used with the aforementioned stripping step of (i).

[Influence of Cyclic Siloxane Purification on Polyimide Film]

The YI value for a film thickness of 10 m of the polyimide film obtained from the resin composition of the present embodiment is preferably 20 or less, more preferably 18 or less, still more preferably 16 or less, particularly preferably 14 or less, particularly preferably 13 or less, particularly preferably 10 or less, or particularly preferably 7 or less, from the viewpoint of obtaining favorable optical properties. Moreover, the YI value varies depending on the monomer backbone of the polyimide precursor, but if the monomer backbone is the same, the larger the weight-average molecular weight of the polyimide precursor is, the smaller the YI value tends to be.

Further, the YI value is influenced by, for example, the amine value of the silicon-containing compound used, and when the amine value is high, the YI value is large, and when the amine value is small, the YI value tends to be small. However, in the case of a polyimide precursor using a purified silicon-containing compound and i.e., having a total amount of the compound represented by formula (4) within the aforementioned range, the YI value of the polyimide resin film obtained tends to be lower than that of the polyimide precursor using a unpurified silicon-containing compound having the same amine value. While not wishing to be bound by the mechanism of action, the present inventors conjecture the reason as follows. Namely, in the conventional purification method, non-cyclic low molecular weight diamine used in the preparation of the polyimide precursor remains and decomposes upon curing of the polyimide to generate radicals, which can be a cause of allowing the YI value to be increased (deteriorated). It is also conjectured that when reducing the amount of the cyclic siloxane represented by formula (4), not only the cyclic siloxane represented by formula (4) is removed singly upon purification, but also among diamine components which increase the amine value, low molecular weight diamines that are relatively volatiable are removed. Therefore, it is surmised that the polyimide precursor in which the total amount of the compound represented by formula (4) was reduced according to the present embodiment further improve the YI value of the polyimide resin film. In the conventional purification method, it is difficult to reduce the non-cyclic low molecular weight diamine, and therefore even if purification is carried out, the degree of improvement of the YI value of the polyimide resin film is considered to be smaller than that of the present embodiment.

[Rth: Retardation]

The Rth of the polyimide film has a correlation with a monomer backbone of the polyimide precursor, and the use of the monomer having a fluorene backbone tends to lower Rth. While not being bound by the mechanism of action, this tendency is considered to be correlated with the orientation and/or crystallinity of the molecules in the polyimide film.

When the polyimide film is used as a display material, Rth is preferably 200 nm or less and more preferably 100 nm or less. When Rth is greater than 200, the color reproducibility of the image is poor, and in particular, it is difficult to correctly capture the image.

[Coating Evaluation: Slit Nozzle Evaluation]

The slit nozzle evaluation of the resin composition comprising the polyimide precursor correlates with the weight-average molecular weight of the polyimide precursor and the solid content of the resin composition. In the case of a low molecular weight of a precursor and preparing a varnish with a low solid content, liquid leakage occurs, which is inappropriate, and in the case of a high molecular weight of the precursor and preparing a varnish with a high solid content, clogging occurs at a tip of slit nozzle, which is also inappropriate. It is necessary to apply an appropriate weight-average molecular weight range and an appropriate solid content range.

[Coating Evaluation: Coat Gap]

The coat gap in slit coating has a correlation with the solid content of the resin composition comprising the polyimide precursor, and a lower solid content is more preferable. The coat gap is preferably larger and if it is less than 50 m, there is a likelihood that a slit nozzle and a glass substrate collide with each other when flatness of the glass is poor, and especially when a size of the substrate becomes larger, there is a higher likelihood of the collision, thereby being inappropriate from the viewpoint of damage of the slit nozzle.

[Coating Evaluation: Edge Evaluation]

When a weight-average molecular weight of the polyimide precursor is relatively low and a varnish with a low solid content is prepared, dripping at an edge (phenomenon in which a varnish drips from a coating region after coating and spreads to a uncoating region) occurs, which is inappropriate. When a weight-average molecular weight of the polyimide precursor is relatively high and a varnish with a low solid content is prepared, edge beading (phenomenon in which a thickness of an edge of a coating region is increased) occurs, which is also inappropriate. Thus, it is necessary to employ an appropriate weight-average molecular weight range and appropriate solid content range.

[Factors Contributing to Larger Molecular Weight of Polyimide Precursor]

As described above, in terms of coating evaluation, the weight-average molecular weight of the polyimide precursor is preferably 70,000 or more. The following factors are considered to be correlated with rendering the My of the polyimide precursor 70,000 or more (hereinafter, also referred to as larger molecular weight).
(1) The water content of the monomer and the solvent is low. When the water content is high, the acid dianhydride decomposes into tetracarboxylic acid and the reactivity with the diamine decreases. In the comparative Example to be described later, the synthesis solvent was used after an elapse of one day or longer after opening, and the monomer was used without carrying out a drying treatment, etc. On the other hand, in the Examples, the solvent was used immediately after opening, and the monomer was used after drying treatment. As a result, a larger weight-average molecular weight polyimide precursor was obtained in the Examples.
(2) The molar ratio of the diamine and the acid dianhydride used in the synthesis is adjusted to as equimolar (1:1) as possible. In this case, since some of the acid dianhydride is surmised to have decomposed by moisture, etc., in the atmosphere, the decomposed substance is considered important to also be taken into account for a number of moles of the acid dianhydride. In the Examples to be described later, a polyimide precursor having a larger weight-average molecular weight could be obtained as the molar ratio of the diamine and the acid dianhydride is closer to equimolar.
(3) The reaction temperature is adjusted as low as possible, and preferably adjusted to the lowest temperature provided the monomer is soluble in the solvent. For example, it is adjusted to room temperature as the lowest set temperature, and to lower than about 80° C. as the highest temperature. When the reaction system is set at an elevated temperature, it is conjectured that there is a likelihood of decomposition of the polyimide precursor when polymerizing it, leading to lower degree of polymerization. In the Examples to be described below, as the synthesis temperature of the polyimide precursor was lower, a polyimide precursor having a larger weight-average molecular weight could be obtained.

[Applications of Polyimide Film]

The polyimide film obtained from the resin composition of the present embodiment can be applied to, for example, a semiconductor dielectric film, a thin film transistor liquid crystal display (TFT-LCD) insulating film, and an electrode protective film, and additionally to transparent substrates, etc., of display devices such as a liquid crystal display, an organic electroluminescent display, a field emission display, an electronic paper, etc. In particular, the polyimide film obtained from the resin composition of the present embodiment is suitably used as a thin film transistor (TFT) substrate, a color filter substrate, a touch panel substrate, and a substrate of a transparent conductive film (ITO, Indium Thin Oxide) in manufactures of flexible devices. As flexible devices to which the polyimide film in this embodiment can be applied, for example, a TFT device for flexible displays, a flexible solar cell, a flexible touch panel, a flexible illumination, a flexible battery, a flexible printed circuit, a flexible color filter, a surface cover lens for cellular phones, etc.

The step of fabricating a TFT on a flexible substrate using the polyimide film is typically carried out at a wide range of temperatures from 150 to 650° C. Specifically, when producing a TFT device using amorphous silicon, process temperatures of 250° C. to 350° C. are generally required, and the polyimide film of the present embodiment needs to withstand the temperatures thereof. Specifically, it is necessary to appropriately select a polymer structure having a glass transition temperature and thermal decomposition temperature higher than the process temperatures.

In the case of fabricating a TFT device using a metal oxide semiconductor (IGZO, etc.), process temperatures of 320° C. to 400° C. are generally required, and the polyimide film of the present embodiment needs to withstand the temperatures thereof. Therefore, it is necessary to appropriately select a polymer structure having a glass transition temperature and thermal decomposition temperature higher than the maximum temperature in the TFT fabricating process.

When fabricating a TFT device using low temperature polysilicon (LTPS), process temperatures of 380° C. to 520° C. are generally required, and the polyimide film of the present embodiment needs to withstand the temperatures thereof. Thus, it is necessary to appropriately select a glass transition temperature and thermal decomposition temperature higher than the maximum temperature in the TFT fabricating process.

On the other hand, due to these heat histories, the optical properties (in particular, light transmittance, retardation property and YI value) of the polyimide film tend to deteriorate as they are exposed to elevated temperature processes. However, the polyimide obtained from the polyimide precursor of the present embodiment has favorable optical properties even after such heat histories.

In the following, methods for manufacturing a display and laminate will be explained as application examples of the polyimide film of the present embodiment.

[Display Manufacturing Method]

The method for manufacturing a display in the present embodiment comprises: a coating step of coating a surface of a support with the resin composition of the present embodiment; a film forming step of forming a polyimide resin film by heating the aforementioned resin composition; an element forming step of forming an element on the aforementioned polyimide resin film, and a stripping step of stripping the polyimide resin film on which the aforementioned element was formed from the support.

<Examples of Manufacture of Flexible Organic EL Display>

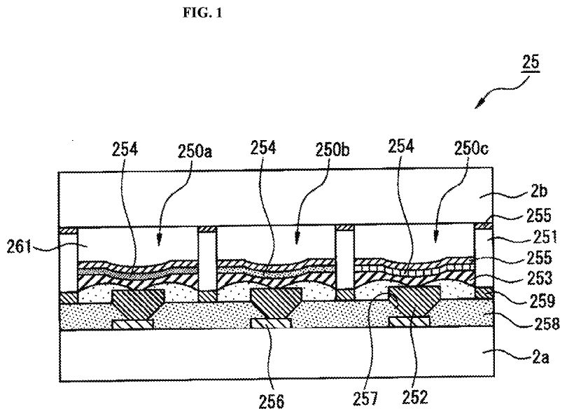

FIG. 1 is a schematic diagram illustrating the structure of the Top-emission flexible organic EL display, which is the upper portion of the polyimide substrate, as an example of the display of the present embodiment.

The organic EL structure unit 25 of FIG. 1 will be explained. For example, the organic EL element 250a that emits red light, the organic EL element 250b that emits green light, and the organic EL element 250c that emits blue light are arranged in the matrix as one unit, and the light emitting area of each organic EL element is separated by each partition wall 251 (bank). Each organic EL element consists of the lower electrode (anode) 252, the hole transport layer 253, the light emitting layer 254, and the upper electrode (cathode) 255. Moreover, on the lower layer 2a that is a CVD multilayer film (multi barrier layer) made of silicon nitride (SiN) and/or silicon oxide (SiO), the TFT 256 (selected from low temperature polysilicon (LTPS) and a metal oxide semiconductor (such as IGZO, etc.)) for driving the organic EL elements, the interlayer dielectric film 258 provided with each contact hole 257, and a plurality of the lower electrodes 259, are disposed. The organic EL elements are sealed by the sealing substrate 2b, and the hollow portion 261 is formed between each organic EL element and the sealing substrate 2b.

The step of manufacturing the flexible organic EL display includes a step of fabricating the polyimide film on the glass substrate support to manufacture the organic EL substrate shown in FIG. 1 above the film, a step of manufacturing the sealing substrate, an assembly step of combining and attaching the both substrates, and a stripping step of stripping the organic EL display fabricated on the polyimide film from the glass substrate support.

Publicly known manufacturing steps can be applied to the organic EL substrate manufacturing step, the sealing substrate manufacturing step, and the assembly step. The examples thereof will be given below without being limited thereto. Note that the stripping step is the same as the stripping step of the polyimide film as described above.

For example, as referred to FIG. 1, the polyimide film is first prepared on the glass substrate support by the above method, and the multi-barrier layer (lower substrate 2a in FIG. 1) consisting of the double layer of silicon nitride (SiN) and silicon oxide (SiO) is fabricated on the polyimide by a CVD method or sputtering method followed by fabrication of the metal wiring layer for driving a TFT on the multi-barrier layer using a photoresist, etc. The active buffer layer of SiO, etc., is fabricated thereon by the CVD method, and the TFT device (TFT 256 in FIG. 1) such as a metal oxide semiconductor (IGZO) or low temperature polysilicon (LTPS), etc., is fabricated thereon. After fabricating the TFT substrate for the flexible display, the interlayer dielectric film 258 provided with contact holes 257 is formed using a photosensitive acrylic resin, etc. The ITO film is formed by sputtering, etc., and the lower electrode 259 is formed so as to be a counterpart of the TFT.

Next, after each partition (bank) 251 is formed by a photosensitive polyimide, etc., the hole transport layer 253 and the light emitting layer 254 are formed in each space separated by the partition. Further, the upper electrode (cathode) 255 is formed so as to cover the light emitting layer 254 and the partitions (banks) 251. Thereafter, using a fine metal mask, etc., as a mask, the organic EL substrate is fabricated by a publicly known method by depositing an organic EL material (corresponding to the organic EL element 250a that emits red light in FIG. 1) emitting red light, an organic EL material (corresponding to the organic EL element 250b that emits green light in FIG. 1) emitting green light and an organic EL material (corresponding to the organic EL element 250c that emits blue light in FIG. 1) emitting blue light. The organic EL substrate is sealed with the sealing film, etc., (sealing substrate 2b in FIG. 1), and the device above the polyimide substrate is stripped from the glass substrate support by a publicly known stripping method such as laser stripping, etc., then to fabricate a Top-emission flexible organic EL display. When the polyimide of the present embodiment is used, a see-through flexible organic EL display can be fabricated. Further, a Bottom-emission flexible organic EL display may be fabricated by a publicly known method.

<Examples of Manufacturing Flexible Liquid Crystal Display>

A flexible liquid crystal display can be fabricated using the polyimide film of the present embodiment. As a specific fabricating method, a polyimide film is fabricated on a glass substrate support by the above method, and a TFT substrate consisting of, for example, amorphous silicon, a metal oxide semiconductor (IGZO, etc.), and low temperature polysilicon is fabricated by applying the above method. Separately, according to the coating and the film forming steps of the present embodiment, a polyimide film is fabricated on a glass substrate support, and a color filter glass substrate (CF substrate) provided with the polyimide film is fabricated using a color resist, etc., according to a publicly known method. To either the TFT substrate and the CF substrate, a surface of a frame-like pattern without the portion of the liquid crystal injection port is coated with a sealing material consisting of a thermosetting epoxy resin, etc., by screen printing, and to the other substrate, spherical spacers having a diameter equivalent to the thickness of the liquid crystal layer and consisting of a plastic material or silica, are scattered.

Then, the TFT substrate and the CF substrate are combined and attached together, and the sealing material is cured. Thereafter, a liquid crystal material is injected by an evacuation method into the space surrounded by the TFT substrate, the CF substrate, as well as the sealing material, the surface of the liquid crystal injection port is coated with a thermosetting resin, and the liquid crystal material is sealed with heating to form a liquid crystal layer. Finally, the flexible liquid crystal display can be fabricated by stripping the glass substrate on the CF side and the glass substrate on the TFT side, respectively at the interface between the polyimide film and the glass substrate by a laser stripping method, etc.

<Manufacturing Method of Laminate>

The method for manufacturing a laminate in the present embodiment comprises: a coating step of coating a surface of a support with the resin composition of the present embodiment; a film forming step of forming a polyimide resin film by heating the aforementioned resin composition, and an element forming step of forming an element on the aforementioned polyimide resin film.

As an element in the laminate, the elements illustrated in the manufacture of the aforementioned flexible device, are included. For example, a glass substrate can be used as a support. Preferred specific procedures of the coating step and the film forming step are the same as those in the manufacturing method of the polyimide film described above. In the element forming step, the aforementioned element is also formed on a polyimide resin film as a flexible substrate, formed on the support. Thereafter, the polyimide resin film and the element may be optionally stripped off from the support in the stripping step.

### EXAMPLES

Although the following provides a detailed explanation of the present invention in way of Examples thereof, these will be described for the purpose of explanation, and the scope of the present invention is not limited to the following Examples. Measurements, purification and evaluation in the Examples and Comparative Examples were carried out in accordance with the methods indicated below.

<<Measurement and Evaluation Method>>

### <Weight-Average Molecular Weight>

The weight-average molecular weight (Mw) and the number-average molecular weight (Mn) were measured by gel permeation chromatography (GPC) under the following conditions.

As a solvent, NMP (for high performance liquid chromatograph manufactured by Wako Pure Chemical Industries Ltd., with 24.8 mmol/L of lithium bromide monohydrate (manufactured by Wako Pure Chemical Industries Ltd., purity: 99.5%) and 63.2 mmol/L of phosphoric acid (for high performance liquid chromatograph, manufactured by Wako Pure Chemical Industries, Ltd.), being added and dissolved to NMP just before measurement), was used. A calibration curve for calculating the weight-average molecular weight was prepared using standard polystyrenes (manufactured by Tosoh Corporation).
Column: Shodex KD-806M (manufactured by Showa Denko K.K.)
Flow rate: 1.0 mL/minute
Column temperature: 40° C.
Pump: PU-2080Plus (manufactured by JASCO Corporation)
Detector: RI-2031Plus (RI: differential refractometer, manufactured by JASCO Corporation) and UV-2075Plus (UV-VIS: ultraviolet-visible spectrophotometer, manufactured by JASCO Corporation).

<Solid Content>

The total weight of the monomers used for the polyimide precursor can be used as the weight of the solid content contained in the resin composition. Alternatively, the solid content weight was obtained by determining a weight of the solvent by gas chromatography (hereinafter also referred to as GC) analysis of the resin composition and subtracting the weight of the solvent from the weight of the resin composition.

The conditions of GC include the following.
Apparatus: Gas chromatograph (gas chromatograph type 6890N manufactured by Agilent Technologies Japan, Ltd.)
Inlet temperature: 280° C.
Injection volume: 1 μL
Oven temperature: The temperature was held for 1 minute at 50° C. and then raised to 350° C. at the heating rate of 20° C./minute, and held for 5 minutes at 350° C.
Carrier gas: He, 1.0 ml/minute
Column: BPX5 (0.25 mmϕ×30 m, film thickness: 0.25 m) manufactured by SGE Analytical Science Pty.
Split ratio: 50:1
Detector: Hydrogen flame ionization detector
Detector temperature: 355° C.

<Coating Evaluation>

Coating evaluation was carried out using a slit coater (manufactured by SCREEN Finetech Solutions Co., Ltd.) for the polyimide precursor compositions synthesized in Examples, Comparative Examples, and Reference Examples.

The results on the coating evaluation are described in Tables 2 to 12.

(Slit Nozzle Evaluation)

After the polyimide precursor compositions (varnishes) synthesized in Examples, Comparative Examples, and Reference Examples were filled into the slit coater, the behavior of each varnish was evaluated and ranked according to the following criteria and the evaluation results were described in the Tables.

After starting varnish discharging from the nozzle and then stopping discharging,
when the varnish drips down from the slit nozzle, it is judged as: Liquid leakage
when no varnish is discharged from the nozzle, i.e., no discharge due to clogging, it is judged as: Liquid drip (the table is also to be corrected)
when the varnish is coatable without clogging, it is judged as: No problem.

(Coat Gap)

A surface of a glass substrate was coated (coating speed 100 mm/second) to the film thickness of 10 m after the following imidization, with each of the polyimide precursor compositions (varnishes) synthesized in Examples, Reference Examples, and Comparative Examples and subjected to imidization (by heating at 100° C. for 1 hour at an oxygen concentration of 10 ppm by weight or less followed by further heating for 30 minutes at 400° C.). The set value of the coat gap of the slit coater for each case is shown in Tables 2 to 10.

(Edge Evaluation)

A surface of a glass substrate was coated with each of the polyimide precursor compositions synthesized in Examples, Comparative Examples, and Reference Examples, and the substrate was moved to a drying furnace and heated at 100° C. for 1 hour. Thereafter, the edge of the coating film was observed using a microscope at a magnification of 10× and ranked according to the following criteria to evaluate beading.

Further, using a stylus type profilometer (P-15: manufactured by KLA-Tencor Corporation), the edge bead (accumulation of coated materials at the edge) of the coating film was measured and ranked according to the following criteria.

When a liquid drip of 0.5 mm or more is observed by microscopic observation of the edge portion: Liquid drip.

When a thickness of the bead is 50% or more of the coating film thickness in the film thickness measurement of the edge portion: Bead drip.

When no edge abnormality is observed: No problem

(Slit Coating Coatability)

With respect to the aforementioned slit nozzle evaluation, coat gap, and edge evaluation, these were evaluated according to the following criteria and the evaluated results were described in the tables.

When a composition using a polyimide precursor having a certain polymerization-average molecular weight satisfies all the following evaluation results for any of the solid contents of the compositions: Acceptable

When a composition using a polyimide precursor having a certain polymerization-average molecular weight satisfies none of the following evaluation results for any of the solid contents of the compositions: Unacceptable
Slit nozzle evaluation: No problem
Coat gap: 50 um or more
Edge evaluation: No problem

<Analysis of Concentration of Low Molecular Weight Cyclic Siloxane>

The concentration analysis of the silicon-containing compound (hereafter also referred to as SiDA) as a raw material and the low molecular weight cyclic siloxane of formula (4) contained in the resin composition of the present embodiment, was carried out by GC/MS measurement as described below.

(1) Outline

First, a calibration line for quantifying the amount of cyclic siloxane was prepared. The calibration line was prepared according to the method described below using a standard (manufactured by Tokyo Chemical Industry Co., Ltd.) of n=4 cyclic siloxane (hereinafter also referred to as D4) of formula (4).

The amount of low molecular weight cyclic siloxane contained in SiDA was measured by heating the SiDA at 100° C. for 10 minutes in a pyrolyzer and analyzing the volatile components generated by GC/MS. The peak area of each of the obtained compounds was converted to the D4 concentration using the calibration line preliminarily prepared.

The amount of low molecular weight cyclic siloxane contained in the resin composition was measured by heating SiDA at 100° C. for 10 minutes in a pyrolyzer and analyzing the volatile components generated by GC/MS. The peak area of each of the obtained compounds was converted to the D4 concentration using the calibration line preliminarily prepared.
GC/MS measurement was carried out using the following apparatus.
Pyrolyzer: Py-3030 iD (Frontier Lab)
GC system: 7890B (Agilent Technology)
MSD: 5977A (Agilent Technology)
Column: UA-1 (inner diameter: 0.25 mm, length: 15 m, liquid phase thickness: 0.25 m) (Frontier Lab)
GC/MS measurement was carried out under the following measurement conditions for all the measurements.
Column temperature: The temperature was held at 40° C. for 5 minutes, then raised at the heating rate of 20° C./minute and held at 320° C. for 11 minutes (total duration time of 30 minutes).
Inlet temperature: 320° C.
Injection method: Split method (split ratio 1/20)
Interface temperature: 320° C.
Ion source temperature: 230° C.
Ionization method: Electron ionization method (EI)
Measurement method: SCAN method (m/z 10-800)

(2) Preparation of Calibration Line

A standard (manufactured by Tokyo Chemical Industry Co., Ltd.) of the compound wherein n=4 in formula (4) (hereinafter also referred to as D4) was weighed into a 10 mL-volumetric flask and chloroform was used as a solvent to prepare a sample with a concentration of 0.1 mg/mL of D4 and a sample with a concentration of 0.01 mg/ml of D4.

A sampler suitable for sampling liquids was fitted to a pyrolyzer set at 400° C. and 1 μL of the aforementioned sample having the adjusted concentration was weighted with a microsyringe and injected into the pyrolyzer. While heating the pyrolyzer at 400° C., the column was immersed in liquid nitrogen to trap volatile components in the column. After an elapse of one minute after heating was completed, the column was taken out from liquid nitrogen and subjected to GC/MS measurement. From the D4 concentrations and the peak areas obtained, the calibration line was prepared.

The retention time of each cyclic siloxane in GC/MS measurement using the aforementioned apparatus and measurement conditions are listed in Table 1 below. The same applies to the subsequent GC/MS measurements.

TABLE 1

| Compounds | Retention time (minute) |
|---|---|
| D3 | 3:08 |
| D4 | 7:35 |
| D5 | 9:12 |
| D6 | 10:30 |
| D7 | 11:37 |
| D8 | 12:30 |
| Dimethyl 2 diphenyl 1 | 12:57 |
| Dimethyl 3 diphenyl 1 | 13:33 |
| Dimethyl 4 diphenyl 1 | 14:14 |
| Dimethyl 5 diphenyl 1 | 15:00 |
| Dimethyl 6 diphenyl 1 | 15:40 |

The Di (i=3 to 8) in the above Table 1 each denotes the cyclic siloxane corresponding to i in the formula (8) below. In addition, dimethyl j diphenyl l (j=2 to 6) in Table 1 above is the cyclic siloxane corresponding to j in the following formula (7).

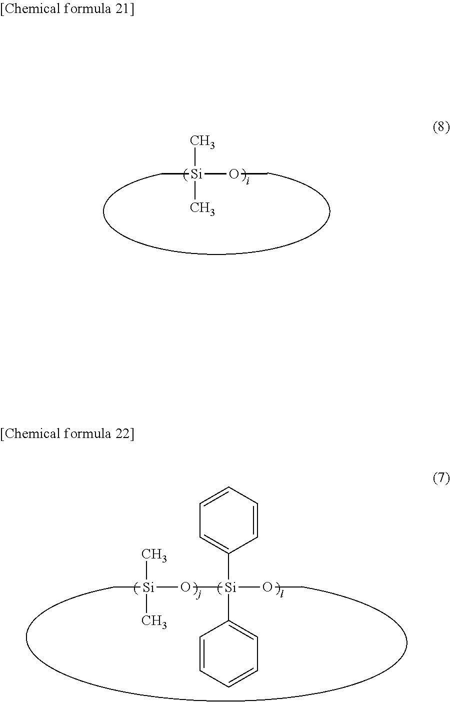

(3) Analysis of Concentration of Low Molecular Weight Cyclic Siloxane of Formula (4) in Silicon-Containing Compound

Analysis of the concentration of the low molecular weight cyclic siloxane of formula (4) contained in SiDA was carried out by heating it to 100° C. and subjecting to GC/MS measurement of volatilized components generated. A sample cup containing SiDA weighed at about 20 mg was placed in a heating furnace (He atmosphere) of a pyrolyzer set at 100° C. and heated at 100° C. for 10 minutes. The column was immersed in liquid nitrogen during heating of the sample at 100° C. to trap volatile components in the column. After heating was completed, the sample cup was removed from the heating furnace, and after one minute the column was taken out from the liquid nitrogen, the sample was subjected to GC/MS measurement. The peak area of each of the obtained compounds was converted to the D4 concentration using the calibration line preliminarily prepared. The concentrations of the low molecular cyclic siloxanes (total amount the compounds wherein r=3 to 8 in formula (4), based on the silicon-containing compound) before and after the purification treatment of the silicon-containing compound to be described below are shown in Table 11.

(4) Analysis of Concentration of Low Molecular Weight Cyclic Siloxane of Formula (4) in Solid Content

The concentration of the low molecular weight cyclic siloxane of formula (4) contained in the solid content was calculated from the concentration of the low molecular weight cyclic siloxane of formula (4) in the resin composition that is to be described below. Accordingly, the total weight of the monomers used for the polyimide precursor of each Example and Comparative Example is regarded as the weight of the solid content contained in the resin composition, and from the cyclic siloxane concentration of formula (4) in the resin composition and the total weight of the cyclic siloxanes, the cyclic siloxane concentration of formula (4) in the solid content was calculated.

The concentrations of the low molecular cyclic siloxanes (total amount the compounds wherein r=3 to 8 in formula (4), based on the solid content weight) before and after the purification treatment of the silicon-containing compound to be described below are shown in Table 11.

(5) Analysis of Concentration of Low Molecular Weight Cyclic Siloxane of Formula (4) in Resin Composition

Analysis of the concentration of low molecular weight cyclic siloxane of formula (4) in the resin composition was carried out under the condition of simulating a prebake process for a transparent polyimide, in which precipitation of cyclic siloxane is concerned. The resin compositions of Examples and Comparative Examples were each heated to 100° C. and GC/MS measurement of the volatilized components was carried out. The concentration of each compound was calculated from the measurement result on the peak area of the volatile components in the resin composition. If the peak of each compound did not overlap with peaks of the other compounds, the peak area determined from the total ion chromatogram (TIC) was used. When the peak of each compound and the peaks of the other compounds overlap, the peak area obtained from the mass chromatogram (MS) of m/z=281 was used. A sample cup containing the resin composition weighed at about 20 mg was placed in a heating furnace (He atmosphere) of a pyrolyzer set at 100° C. and heated at 100° C. for 30 minutes. The resulting volatile components were measured by GC/MS analysis. The peak area of each of the obtained compounds was converted to the D4 concentration using the calibration line preliminarily prepared.

The concentrations of the low molecular cyclic siloxanes (total amount the compounds wherein r=3 to 8 in formula (4), based on the solid content weight) before and after the purification treatment of the silicon-containing compound to be described below are shown in Table 11.

<Film Evaluation YI (Yellowness)>

In this evaluation, the difference in the YI value of the polyimide resin film obtained by curing the polyimide precursor using the purified silicon compound, and the polyimide resin film obtained by curing the precursor using the silicon compound without purification, was evaluated.

With each of the polyimide precursor compositions of Examples, a surface of a 200 mm square alkali-free glass substrate (hereinafter, also referred to as a glass substrate) was coated to a film thickness of 10 m after curing to form a coating film. The coating was carried out using a slit coater (TN25000, Tokyo Ohka Kogyo Co., Ltd.). One of the glass substrates with the coating film of the obtained polyimide precursor composition was dried at 100° C. for 30 minutes in a nitrogen atmosphere (oxygen concentration of 300 ppm or less) in an oven (KLO-30NH, Koyo Thermo System Co., Ltd.) to remove a solvent. Thereafter it was heated at 400° C. under a nitrogen atmosphere (oxygen concentration 300 ppm or less) for 1 hour to form a polyimide resin film on the glass substrate.

Using the obtained polyimide resin film, the YI value was measured with a spectrophotometer SE600 manufactured by Nippon Denshoku Kogyo Co., Ltd. As a light source, a D65 light source was used. The difference in YI value was determined from the following equation.

(Difference in YI value)=(YI value of a polyimide resin film by curing a polyimide precursor obtained using the silicon compound without purification)−(YI value of a polyimide resin film by curing a polyimide precursor obtained using the purified silicon compound)

Upon obtaining the difference in YI value, curing of a polyimide precursor obtained using the silicon compound without purification and curing of a polyimide precursor obtained using the purified silicon compound were carried out by heating these two polyimide precursors in a butch of the same oven, from which an instrumental error was eliminated. The results are listed in Table 11.

<Rth (Retardation, Retardation in Thickness Direction)>

With each of the polyimide precursor compositions of Examples and Comparative Examples, a surface of a 200 mm square alkali-free glass substrate (hereinafter, also referred to as a glass substrate) was coated to a film thickness of 10 m after curing to form a coating film. The coating was carried out using a slit coater (TN25000, Tokyo Ohka Kogyo Co., Ltd.). One of the glass substrates with the coating film of the obtained polyimide precursor composition was dried at 100° C. for 30 minutes in a nitrogen atmosphere (oxygen concentration of 300 ppm or less) in an oven (KLO-30NH, Koyo Thermo System Co., Ltd.) to remove a solvent, and heated at 400° C. under a nitrogen atmosphere (oxygen concentration 300 ppm or less) for 1 hour to form a polyimide resin film on the glass substrate.

The Rth (converted to a film thickness of 10 m) of the polyimide film thus fabricated was measured using a retardation birefringence measurement apparatus (KOBRA-WR manufactured by Oji Scientific Instruments Co., Ltd.). The wavelength of the measurement light was 589 nm.

<<Purification Method of Silicon-Containing Compound>>

The silicon-containing compounds described in Examples and Comparative Examples described below were subjected to the following purification treatment to reduce the low molecular weight cyclic siloxane contained. The concentration of the low molecular weight cyclic siloxane after purification was analyzed according to the above method.

### [Purification Method]

10 kg of the silicon-containing compound was charged into a flask, and stripping was carried out while blowing nitrogen gas for 8 hours at a temperature of 160° C. and a pressure of 270 Pa.

[Drying Treatment of Monomer]

Immediately after opening, each monomer (acid dianhydride, diamine, silicon-containing compound) was dried using a vacuum dryer (AVO-310NS, sold by AS ONE Corporation) under conditions of 80° C. and 2000 to 3000 Pa for 24 hours or longer. After drying, it was used for the following synthesis within one hour.

### EXAMPLES AND COMPARATIVE EXAMPLES

In each of Comparative Examples to be described later, each monomer (acid dianhydride, diamine, silicon-containing compound) was used after an elapse of one day or longer after opening, and in each Example, “monomer drying treatment” described above was carried out for each monomer immediately after opening and then it was used for synthesis.

In each of Comparative Examples described later, a solvent (NMP, GBL) used for synthesis was used after an elapse of one day or longer after opening, and in each Example described later, the one immediately after opening was used.

The silicon-containing compounds in the Tables to be described later, which are described as “without treatment” in the purification treatment column, were used as they were without purification treatment, and those described as “with treatment” were used after purification under the aforementioned purification conditions.

### Comparative Example 1-5

NMP (201 g) was added to a 3 L separable flask with a stirring rod while introducing nitrogen gas, and TFMB (31.1 g) as diamine and X-22-1660B-3 (13.20 g) as a silicon-containing compound were added with stirring, followed by addition of BPAF (22.9 g) and PMDA (10.9 g) as acid dianhydrides (molar ratio of the acid dianhydride and the diamine of 100:100). Next, the mixture was heated to 80° C. in an oil bath with stirring for 3 hours, then the oil bath was removed, and the mixture was returned to room temperature to obtain a transparent NMP solution of polyamic acid (hereinafter also referred to as varnish). The obtained varnish was stored in a freezer and was defrosted when used for evaluation.

### Comparative Examples 1-1 to 1-4

Each varnish was prepared in the same manner as in Comparative Example 1-5 with the exception of adding NMP after stirring for 3 hours at 80° C. and adjusting the solid content to that in Table 2 in Comparative Example 1-5.

### Example 1-1

The varnish was prepared in the same manner as in Comparative Example 1-5 with the exception of changing the amount of NMP to 233 g and the amounts of TFMB, X-22-1660B-3, BPAF, and PMDA to the amounts thereof (molar ratio of acid dianhydride and diamine of (100:99)) listed in Table 2, respectively, in Comparative Example 1-5.

### Examples 1-2, 1-3

Each varnish was prepared in the same manner as in Comparative Example 1-5 with the exception of changing the amount of NMP to 441 g, the amounts of TFMB, X-22-1660B-3, BPAF, and PMDA to the amounts thereof (molar ratio of acid dianhydride and diamine of (100:99)) listed in Table 1, respectively, and changing the reaction condition to stirring at 40° C. for 12 hours in Comparative Example 1-5.

### Examples 1-4

The varnish was prepared in the same manner as in Example 1-2 with the exception of changing the synthesis solvents to NMP of 220 g and GLB of 220 g in Example 1-2.

### Example 1-5

The varnish was prepared in the same manner as in Comparative Example 1-5 with the exception of changing the amount of NMP to 441 g, the amounts of TFMB, X-22-1660B-3, BPAF, and PMDA to the amounts thereof (molar ratio of acid dianhydride and diamine of (99:100)) listed in Table 2, respectively, and changing the reaction condition to stirring for 48 hours at room temperature in Comparative Example 1-5.

### Example 1-6

The varnish was prepared in the same manner as in Example 1-5 with the exception of changing X-22-1660B-3 to the compound listed in Table 2 in Example 1-5.

### Example 1-7

The varnish was prepared in the same manner as in Comparative Example 1-5 with the exception of changing the amount of NMP to 786 g, the amounts of TFMB, X-22-1660B-3, BPAF, and PMDA to the amounts thereof (molar ratio of acid dianhydride and diamine of (100:99)) listed in Table 2, respectively, and changing the reaction condition to stirring for 48 hours at room temperature in Comparative Example 1-5.

### Comparative Example 2-5

NMP (238 g) was added to a 3 L separable flask with a stirring rod while introducing nitrogen gas, and TFMB (30.9 g) as diamine and X-22-1660B-3 (15.84 g) as a silicon-containing compound were added with stirring, followed by addition of BPAF (45.8 g) as acid dianhydride (molar ratio of the acid dianhydride and the diamine of 100:100). Next, the mixture was heated to 80° C. in an oil bath with stirring for 3 hours, then the oil bath was removed, and the mixture was returned to room temperature to obtain the transparent NMP solution of polyamic acid (hereinafter also referred to as varnish). The obtained varnish was stored in a freezer and was defrosted when used for evaluation.

### Comparative Examples 2-1 to 2-4

Each varnish was prepared in the same manner as in Comparative Example 2-5 with the exception of adding NMP after stirring for 3 hours at 80° C. and adjusting the solid content to that in Table 3 in Comparative Example 2-5.

### Example 2-1

The varnish was prepared in the same manner as in Comparative Example 2-5 with the exception of changing the amount of NMP to 277 g and the amounts of TFMB, X-22-1660B-3, and BPAF to the amounts thereof (molar ratio of acid dianhydride and diamine of (100:99)) listed in Table 3, respectively, in Comparative Example 2-5.

### Examples 2-2, 2-3

Each varnish was prepared in the same manner as in Comparative Example 2-5 with the exception of changing the amount of NMP to 522 g, X-22-1660B-3 to the compound listed in Table 3, and the amounts of TFMB, X-22-1660B-3, and BPAF to the amounts thereof (molar ratio of acid dianhydride and diamine of (99:100)) listed in Table 3, respectively, and changing the reaction condition to stirring at 40° C. for 12 hours in Comparative Example 2-5.

### Example 2-4

The varnish was prepared in the same manner as in Example 2-2 with the exception of changing the synthesis solvents to NMP of 261 g and GLB of 261 g in Example 2-2.

### Example 2-5

The varnish was prepared in the same manner as in Example 2-1 with the exception of changing the amount of NMP to 933 g and the reaction condition to stirring for 48 hours at room temperature in Example 2-1.

### Comparative Example 3-5

NMP (229 g) was added to a 3 L separable flask with a stirring rod while introducing nitrogen gas, and TFMB (30.9 g) as diamine and X-22-1660B-3 (15.0 g) as a silicon-containing compound were added with stirring, followed by addition of BPAF-PA (32.1 g) and PMDA (10.9 g) as acid dianhydrides (molar ratio of the acid dianhydride and the diamine of 100:100). Next, the mixture was heated to 80° C. in an oil bath with stirring for 3 hours, then the oil bath was removed, and the mixture was returned to room temperature to obtain the transparent NMP solution of polyamic acid (hereinafter also referred to as varnish). The obtained varnish was stored in a freezer and was defrosted when used for evaluation.

### Comparative Examples 3-1 to 3-4

Each varnish was prepared in the same manner as in Comparative Example 3-5 with the exception of adding NMP after stirring at 80° C. for 3 hours and adjusting the solid content to that in Table 4 in Comparative Example 3-5.

### Example 3-1

The varnish was prepared in the same manner as in Comparative Example 3-5 with the exception of changing the amount of NMP to 266 g and the amounts of TFMB, X-22-1660B-3, BPAF-PA, and PMDA to the amounts thereof (molar ratio of acid dianhydride and diamine of (100:99)) listed in Table 4, respectively, in Comparative Example 3-5.

### Examples 3-2, 3-3

Each varnish was prepared in the same manner as in Comparative Example 3-5 with the exception of changing the amount of NMP to 502 g, X-22-1660B-3 to the compound listed in Table 4 and the amounts of TFMB, X-22-1660B-3, BPAF-PA, and PMDA to the amounts thereof (molar ratio of acid dianhydride and diamine of (99:100)) listed in Table 4, respectively, and changing the reaction condition to stirring at 40° C. for 12 hours in Comparative Example 3-5.

### Example 3-4

The varnish was prepared in the same manner as in Example 3-2 with the exception of changing the synthesis solvents to NMP of 251 g and GLB of 251 g in Example 3-2.

### Example 3-5

The varnish was prepared in the same manner as in Example 3-1 with the exception of changing the amount of NMP to 896 g and the reaction condition to stirring for 48 hours at room temperature in Example 3-1.

### Comparative Example 4-5

NMP (928 g) was added to a 3 L separable flask with a stirring rod while introducing nitrogen gas, and 4,4′-DAS (24.2 g) as diamine and X-22-1660B-3 (11.88 g) as a silicon-containing compound were added with stirring, followed by addition of BPAF (22.9 g) and PMDA (10.9 g) as acid dianhydrides (molar ratio of the acid dianhydride and the diamine of 100:100). Next, the mixture was heated to 80° C. in an oil bath with stirring for 3 hours, then the oil bath was removed, and the mixture was returned to room temperature to obtain the transparent NMP solution of polyamic acid (hereinafter also referred to as varnish). The obtained varnish was stored in a freezer and was defrosted when used for evaluation.

### Comparative Examples 4-1 to 4-4

Each varnish was prepared in the same manner as in Comparative Example 4-5 with the exception of adding NMP after stirring at 80° C. for 3 hours and adjusting the solid content to that in Table 5 in Comparative Example 4-5.

### Example 4-1

The varnish was prepared in the same manner as in Comparative Example 4-5 with the exception of changing the amount of NMP to 209 g and the amounts of 4,4′-DAS, X-22-1660B-3, BPAF, and PMDA to the amounts thereof (molar ratio of acid dianhydride and diamine of (100:99)) listed in Table 5, respectively, in Comparative Example 4-5.

### Examples 4-2, 4-3, and 4-4

Each varnish was prepared in the same manner as in Comparative Example 4-5 with the exception of changing the amount of NMP to 502 g and the amounts of 4,4′-DAS (or 3,3′-DAS), X-22-1660B-3, BPAF, and PMDA to the amounts thereof (molar ratio of acid dianhydride and diamine of (99:100)) listed in Table 5, respectively and changing the reaction condition to stirring at 40° C. for 12 hours in Comparative Example 4-5.

### Example 4-5

The varnish was prepared in the same manner as in Example 4-2 with the exception of changing the synthesis solvents to NMP of 197 g and GLB of 197 g in Example 4-2.

### Example 4-6

The varnish was prepared in the same manner as in Example 4-1 with the exception of changing the amount of NMP to 704 g and the reaction condition to stirring for 48 hours at room temperature in Example 4-1.

### Comparative Example 5-5

NMP (209 g) was added to a 3 L separable flask with a stirring rod while introducing nitrogen gas, and FLDA (33.8 g) as diamine and X-22-1660B-3 (13.64 g) as a silicon-containing compound were added with stirring, followed by addition of BPAF (22.9 g) and PMDA (10.9 g) as acid dianhydrides (molar ratio of the acid dianhydride and the diamine of 100:100). Next, the mixture was heated to 80° C. in an oil bath with stirring for 3 hours, then the oil bath was removed, and the mixture was returned to room temperature to obtain the transparent NMP solution of polyamic acid (hereinafter also referred to as varnish). The obtained varnish was stored in a freezer and was defrosted when used for evaluation.

### Comparative Examples 5-1 to 5-4

Each varnish was prepared in the same manner as in Comparative Example 5-5 with the exception of adding NMP after stirring at 80° C. for 3 hours and adjusting the solid content to that in Table 6 in Comparative Example 5-5.

### Example 5-1

The varnish was prepared in the same manner as in Comparative Example 5-5 with the exception of changing the amount of NMP to 243 g and the amounts of FLDA, X-22-1660B-3, BPAF, and PMDA to the amounts thereof (molar ratio of acid dianhydride and diamine of (100:99)) listed in Table 6, respectively, in Comparative Example 5-5.

### Examples 5-2, 5-3

Each varnish was prepared in the same manner as in Comparative Example 5-5 with the exception of changing the amount of NMP to 458 g and the amounts of FLDA, X-22-1660B-3, BPAF, and PMDA to the amounts thereof (molar ratio of acid dianhydride and diamine of (99:100)) listed in Table 6, respectively, and changing the reaction condition to stirring at 40° C. for 12 hours in Comparative Example 5-5.

### Example 5-4

The varnish was prepared in the same manner as in Example 5-2 with the exception of changing the synthesis solvents to NMP of 229 g and GLB of 229 g in Example 5-2.

### Example 5-5

The varnish was prepared in the same manner as in Example 5-1 with the exception of changing the amount of NMP to 818 g and the reaction condition to stirring for 48 hours at room temperature in Example 5-1

### Comparative Example 6-5

NMP (152 g) was added to a 3 L separable flask with a stirring rod while introducing nitrogen gas, and CHDA (11.2 g) as diamine and X-22-1660B-3 (10.12 g) as a silicon-containing compound were added with stirring, followed by addition of BPAF (22.9 g) and BPDA (14.7 g) as acid dianhydrides (molar ratio of the acid dianhydride and the diamine of 100:100). Next, the mixture was heated to 80° C. in an oil bath with stirring for 3 hours, then the oil bath was removed, and the mixture was returned to room temperature to obtain the transparent NMP solution of polyamic acid (hereinafter also referred to as varnish). The obtained varnish was stored in a freezer and was defrosted when used for evaluation.

### Comparative Examples 6-1 to 6-4

Each varnish was prepared in the same manner as in Comparative Example 6-5 with the exception of adding NMP after stirring at 80° C. for 3 hours and adjusting the solid content to that in Table 7 in Comparative Example 6-5.

### Example 6-1

The varnish was prepared in the same manner as in Comparative Example 6-5 with the exception of changing the amount of NMP to 176 g and the amounts of CHDA, X-22-1660B-3, BPAF, and BPDA to the amounts thereof (molar ratio of acid dianhydride and diamine of (100:99)) listed in Table 7, respectively, in Comparative Example 6-5.

### Examples 6-2, 6-3

Each varnish was prepared in the same manner as in Comparative Example 6-5 with the exception of changing the amount of NMP to 332 g and the amounts of CHDA, X-22-1660B-3, BPAF, and BPDA to the amounts thereof (molar ratio of acid dianhydride and diamine of (99:100)) listed in Table 7, respectively, and changing the reaction condition to stirring at 40° C. for 12 hours in Comparative Example 6-5.

### Example 6-4

The varnish was prepared in the same manner as in Example 6-2 with the exception of changing the synthesis solvents to NMP of 166 g and GLB of 166 g in Example 6-2.

### Example 6-5

The varnish was prepared in the same manner as in Example 6-1 with the exception of changing the amount of NMP to 818 g and the reaction condition to stirring for 48 hours at room temperature in Example 6-1.

### Comparative Example 7-5

NMP (201 g) was added to a 3 L separable flask with a stirring rod while introducing nitrogen gas, and BPAF (22.9 g) as diamine and KF-8012 (13.20 g) as a silicon-containing compound were added with stirring, followed by addition of BPAF (22.9 g) and PMDA (10.9 g) as acid dianhydrides (molar ratio of the acid dianhydride and the diamine of 100:100). Next, the mixture was heated to 80° C. in an oil bath with stirring for 3 hours, then the oil bath was removed, and the mixture was returned to room temperature to obtain the transparent NMP solution of polyamic acid (hereinafter also referred to as varnish). The obtained varnish was stored in a freezer and was defrosted when used for evaluation.

### Comparative Examples 7-1 to 7-4

Each varnish was prepared in the same manner as in Comparative Example 7-5 with the exception of adding NMP after stirring at 80° C. for 3 hours and adjusting the solid content to that in Table 8 in Comparative Example 7-5.

### Example 7-1

The varnish was prepared in the same manner as in Comparative Example 7-5 with the exception of changing the amount of NMP to 233 g and the amounts of BPAF, KF-8012, BPAF, and PMDA to the amounts thereof (molar ratio of acid dianhydride and diamine of (100:99)) listed in Table 8, respectively, in Comparative Example 7-5.

### Examples 7-2, 7-3

Each varnish was prepared in the same manner as in Comparative Example 7-5 with the exception of changing the amount of NMP to 441 g and the amounts of BPAF, KF-8012, BPAF, and PMDA to the amounts thereof (molar ratio of acid dianhydride and diamine of (99:100)) listed in Table 8, respectively, and changing the reaction condition to stirring at 40° C. for 12 hours in Comparative Example 7-5.

### Example 7-4

The varnish was prepared in the same manner as in Example 7-2 with the exception of changing the synthesis solvents to NMP of 220 g and GLB of 220 g in Example 7-2.

### Example 7-5

Each varnish was prepared in the same manner as in Comparative Example 7-5 with the exception of changing the amount of NMP to 441 g and the amounts of TFMB, KF-8012, BPAF, and PMDA to the amounts thereof (molar ratio of acid dianhydride and diamine of (99:100)) listed in Table 8, respectively, and the reaction condition to stirring at room temperature for 48 hours in Comparative Example 7-5.

### Example 7-6

Each varnish was prepared in the same manner as in Comparative Example 7-5 with the exception of changing the amount of NMP to 786 g and the amounts of TFMB, KF-8012, BPAF, and PMDA to the amounts thereof (molar ratio of acid dianhydride and diamine of (100:99)) listed in Table 8, respectively, and changing the reaction condition to stirring at room temperature for 48 hours in Comparative Example 7-5.

### Comparative Example 8-5

NMP (201 g) was added to a 3 L separable flask with a stirring rod while introducing nitrogen gas, and BPAF (22.2 g) as diamine was added with stirring, followed by addition of BPAF (22.2 g) and PMDA (10.6 g) as acid dianhydrides and X-22-168-P5-B (13.44 g) as a silicon-containing compound (molar ratio of the acid dianhydride and the diamine of 100:100). Next, the mixture was heated to 80° C. in an oil bath with stirring for 3 hours, then the oil bath was removed, and the mixture was returned to room temperature to obtain the transparent NMP solution of polyamic acid (hereinafter also referred to as varnish). The obtained varnish was stored in a freezer and was defrosted when used for evaluation.

### Comparative Examples 8-1 to 8-4

Each varnish was prepared in the same manner as in Comparative Example 8-5 with the exception of adding NMP after stirring at 80° C. for 3 hours and adjusting the solid content to that in Table 9 in Comparative Example 8-5.

### Example 8-1

The varnish was prepared in the same manner as in Comparative Example 8-5 with the exception of changing the amount of NMP to 234 g and the amounts of BPAF, X-22-168-P5-B, BPAF, and PMDA to the amounts thereof (molar ratio of acid dianhydride and diamine of (100:99)) listed in Table 9 in Comparative Example 8-5.

### Examples 8-2, 8-3

Each varnish was prepared in the same manner as in Comparative Example 8-5 with the exception of changing the amount of NMP to 441 g, X-22-168-P5-B to the compound listed in Table 9 and the amounts of BPAF, X-22-168-P5-B, BPAF, and PMDA to the amounts thereof (molar ratio of acid dianhydride and diamine of (99:100)) listed in Table 8, respectively, and changing the reaction condition to stirring at 40° C. for 12 hours in Comparative Example 8-5.

### Example 8-4

The varnish was prepared in the same manner as in Example 8-2 with the exception of changing the synthesis solvents to NMP of 222 g and GLB of 222 g in Example 8-2.

### Example 8-5

Each varnish was prepared in the same manner as in Example 8-1 with the exception of changing the amount of NMP to 788 g and the reaction condition to stirring at room temperature for 48 hours in Example 8-1.

### Comparative Example 9-5

NMP (200 g) was added to a 3 L separable flask with a stirring rod while introducing nitrogen gas, and TFMB (32.0 g) as diamine was added with stirring, followed by addition of BPAF (22.0 g) and PMDA (10.5 g) as acid dianhydrides and X-22-168B (13.12 g) as a silicon-containing compound (molar ratio of the acid dianhydride and the diamine of 100:100). Next, the mixture was heated to 80° C. in an oil bath with stirring for 3 hours, then the oil bath was removed, and the mixture was returned to room temperature to obtain the transparent NMP solution of polyamic acid (hereinafter also referred to as varnish). The obtained varnish was stored in a freezer and was defrosted when used for evaluation.

### Comparative Examples 9-1 to 9-4

Each varnish was prepared in the same manner as in Comparative Example 9-5 with the exception of adding NMP after stirring at 80° C. for 3 hours and adjusting the solid content to that in Table 10 in Comparative Example 9-5.

### Example 9-1

The varnish was prepared in the same manner as in Comparative Example 9-5 with the exception of changing the amount of NMP to 232 g and the amounts of TFMB, X-22-168B, BPAF, and PMDA to the amounts thereof (molar ratio of acid dianhydride and diamine of (100:99)) listed in Table 10, respectively, in Comparative Example 9-5.

### Examples 9-2, 9-3

Each varnish was prepared in the same manner as in Comparative Example 9-5 with the exception of changing the amount of NMP to 438 g, the amounts of TFMB, X-22-168B, BPAF, and PMDA to the amounts thereof (molar ratio of acid dianhydride and diamine of (99:100)) listed in Table 10, respectively, and changing the reaction condition to stirring at 40° C. for 12 hours in Comparative Example 9-5.

### Example 9-4

The varnish was prepared in the same manner as in Example 9-2 with the exception of changing the synthesis solvents to NMP of 221 g and GLB of 221 g in Example 9-2.

### Example 9-5

Each varnish was prepared in the same manner as in Example 9-1 with the exception of changing the amount of NMP to 781 g and the reaction condition to stirring at room temperature for 48 hours in Example 9-1.

### Comparative Example 12-1

The varnish was prepared in the same manner as in Example 1-1 with the exception of changing the amount of NMP to 197 g and the amounts of TFMB, X-22-1660B-3, and PMDA to the amounts thereof (molar ratio of acid dianhydride and diamine of (100:99)) listed in Table 12, respectively, in Example 1-1.

### Comparative Example 12-2

The varnish was prepared in the same manner as in Example 1-7 with the exception of changing the amount of NMP to 665 g and the amounts of TFMB, X-22-1660B-3, and PMDA to the amounts thereof (molar ratio of acid dianhydride and diamine of (100:99)) listed in Table 12, respectively, in Example 1-7.

TABLE 2

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Comparative | BPAF | 22.9 | PMDA | 10.9 | TFMB | 31.1 | X-22-1660B-3 | 13.20 | Without |
| Example 1-1 | | | | | | | | | treatment |
| Comparative | BPAF | 22.9 | PMDA | 10.9 | TFMB | 31.1 | X-22-1660B-3 | 13.20 | Without |
| Example 1-2 | | | | | | | | | treatment |
| Comparative | BPAF | 22.9 | PMDA | 10.9 | TFMB | 31.1 | X-22-1660B-3 | 13.20 | Without |
| Example 1-3 | | | | | | | | | treatment |
| Comparative | BPAF | 22.9 | PMDA | 10.9 | TFMB | 31.1 | X-22-1660B-3 | 13.20 | Without |
| Example 1-4 | | | | | | | | | treatment |
| Comparative | BPAF | 22.9 | PMDA | 10.9 | TFMB | 31.1 | X-22-1660B-3 | 13.20 | Without |
| Example 1-5 | | | | | | | | | treatment |
| Example 1-1 | BPAF | 22.9 | PMDA | 10.9 | TFMB | 30.7 | X-22-1660B-3 | 13.20 | Without |
| | | | | | | | | | treatment |
| Example 1-2 | BPAF | 22.9 | PMDA | 10.9 | TFMB | 30.7 | X-22-1660B-3 | 13.20 | Without |
| | | | | | | | | | treatment |
| Example 1-3 | BPAF | 22.9 | PMDA | 10.9 | TFMB | 30.7 | X-22-1660B-3 | 13.20 | With |
| | | | | | | | | | Treatment |
| Example 1-4 | BPAF | 22.9 | PMDA | 10.9 | TFMB | 30.7 | X-22-1660B-3 | 13.20 | Without |
| | | | | | | | | | Treatment |
| Example 1-5 | BPAF | 22.7 | PMDA | 10.8 | TFMB | 31.1 | X-22-1660B-3 | 13.20 | Without |
| | | | | | | | | | Treatment |
| Example 1-6 | BPAF | 22.7 | PMDA | 10.8 | TFMB | 31.1 | X-22-1660B-3 | 13.20 | With |
| | | | | | | | | | Treatment |
| Example 1-7 | BPAF | 22.9 | PMDA | 10.9 | TFMB | 30.7 | X-22-1660B-3 | 13.20 | Without |
| | | | | | | | | | treatment |

| | | | Weight- | | | | | |
|---|---|---|---|---|---|---|---|---|
| | | | average | Solid | Coating evaluation | | | |
| | Monomer | Synthesis | molecular | content | Slit nozzle | Coat gap | Edge | Slit coating |
| | drying | solvent | weight | (wt %) | evaluation | (um) | evaluation | coatability |
| Comparative | Without | NMP | 58,000 | 7 | Liquid | 167 | Liquid drip | Unacceptable |
| Example 1-1 | drying | | | | leakage | | | |
| Comparative | | NMP | 58,000 | 9 | Liquid | 136 | Liquid drip | |
| Example 1-2 | | | | | leakage | | | |
| Comparative | | NMP | 58,000 | 15 | Liquid | 98 | Liquid drip | |
| Example 1-3 | | | | | leakage | | | |
| Comparative | | NMP | 58,000 | 25 | Liquid | 50 | Liquid drip | |
| Example 1-4 | | | | | leakage | | | |
| Comparative | | NMP | 58,000 | 28 | No problem | 41 | No problem | |
| Example 1-5 | | | | | | | | |
| Example 1-1 | With | NMP | 71,000 | 25 | No problem | 50 | No problem | Acceptable |
| | drying | | | | | | | |
| Example 1-2 | With | NMP | 156,000 | 15 | No problem | 98 | No problem | Acceptable |
| Example 1-3 | drying | NMP | 151,000 | 15 | No problem | 98 | No problem | |
| Example 1-4 | | NMP/GBL | 156,000 | 15 | No problem | 110 | No problem | |
| | | (50/50) | | | | | | |
| Example 1-5 | With | NMP | 209,000 | 15 | No problem | 119 | No problem | Acceptable |
| Example 1-6 | drying | NMP | 209,000 | 15 | No problem | 98 | No problem | |
| Example 1-7 | With | NMP | 248,000 | 9 | No problem | 136 | No problem | Acceptable |
| | drying | | | | | | | |

TABLE 3

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Comparative | BPAF | 45.8 | | | TFMB | 30.9 | X-22-1660B-3 | 15.84 | Without |
| Example 2-1 | | | | | | | | | treatment |
| Comparative | BPAF | 45.8 | | | TFMB | 30.9 | X-22-1660B-3 | 15.84 | Without |
| Example 2-2 | | | | | | | | | treatment |
| Comparative | BPAF | 45.8 | | | TFMB | 30.9 | X-22-1660B-3 | 15.84 | Without |
| Example 2-3 | | | | | | | | | treatment |
| Comparative | BPAF | 45.8 | | | TFMB | 30.9 | X-22-1660B-3 | 15.84 | Without |
| Example 2-4 | | | | | | | | | treatment |
| Comparative | BPAF | 45.8 | | | TFMB | 30.9 | X-22-1660B-3 | 15.84 | Without |
| Example 2-5 | | | | | | | | | treatment |
| Example 2-1 | BPAF | 45.8 | | | TFMB | 30.5 | X-22-1660B-3 | 15.84 | Without |
| | | | | | | | | | treatment |
| Example 2-2 | BPAF | 45.4 | | | TFMB | 30.9 | X-22-1660B-3 | 15.84 | Without |
| | | | | | | | | | treatment |
| Example 2-3 | BPAF | 45.4 | | | TFMB | 30.9 | X-22-1660B-3 | 15.84 | With |
| | | | | | | | | | treatment |
| Example 2-4 | BPAF | 45.4 | | | TFMB | 30.9 | X-22-1660B-3 | 15.84 | Without |
| | | | | | | | | | treatment |
| Example 2-5 | BPAF | 45.8 | | | TFMB | 30.5 | X-22-1660B-3 | 15.84 | Without |
| | | | | | | | | | treatment |

| | | | Weight- | | | | | |
|---|---|---|---|---|---|---|---|---|
| | | | average | Solid | Coating evaluation | | | |
| | Monomer | Synthesis | molecular | content | Slit nozzle | Coat gap | Edge | Slit coating |
| | drying | solvent | weight | (wt %) | evaluation | (um) | evaluation | coatability |
| Comparative | Without | NMP | 55,000 | 7 | Liquid | 167 | Liquid drip | Unacceptable |
| Example 2-1 | drying | | | | leakage | | | |
| Comparative | | NMP | 55,000 | 9 | Liquid | 136 | Liquid drip | |
| Example 2-2 | | | | | leakage | | | |
| Comparative | | NMP | 55,000 | 15 | Liquid | 98 | Liquid drip | |
| Example 2-3 | | | | | leakage | | | |
| Comparative | | NMP | 55,000 | 25 | Liquid | 50 | Liquid drip | |
| Example 2-4 | | | | | leakage | | | |
| Comparative | | NMP | 55,000 | 28 | No problem | 41 | No problem | |
| Example 2-5 | | | | | | | | |
| Example 2-1 | With | NMP | 70,000 | 25 | No problem | 50 | No problem | Acceptable |
| | drying | | | | | | | |
| Example 2-2 | With | NMP | 151,000 | 15 | No problem | 98 | No problem | Acceptable |
| Example 2-3 | drying | NMP | 148,000 | 15 | No problem | 98 | No problem | |
| Example 2-4 | | NMP/GBL | 151,000 | 15 | No problem | 110 | No problem | |
| | | (50/50) | | | | | | |
| Example 2-5 | With | NMP | 196,000 | 9 | No problem | 136 | No problem | Acceptable |
| | drying | | | | | | | |

TABLE 4

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Comparative | BPAF-PA | 32.1 | PMDA | 10.9 | TFMB | 30.9 | X-22-1660B-3 | 15.0 | Without |
| Example 3-1 | | | | | | | | | treatment |
| Comparative | BPAF-PA | 32.1 | PMDA | 10.9 | TFMB | 30.9 | X-22-1660B-3 | 15.0 | Without |
| Example 3-2 | | | | | | | | | treatment |
| Comparative | BPAF-PA | 32.1 | PMDA | 10.9 | TFMB | 30.9 | X-22-1660B-3 | 15.0 | Without |
| Example 3-3 | | | | | | | | | treatment |
| Comparative | BPAF-PA | 32.1 | PMDA | 10.9 | TFMB | 30.9 | X-22-1660B-3 | 15.0 | Without |
| Example 3-4 | | | | | | | | | treatment |
| Comparative | BPAF-PA | 32.1 | PMDA | 10.9 | TFMB | 30.9 | X-22-1660B-3 | 15.0 | Without |
| Example 3-5 | | | | | | | | | treatment |
| Example 3-1 | BPAF-PA | 32.1 | PMDA | 10.9 | TFMB | 30.6 | X-22-1660B-3 | 15.0 | Without |
| | | | | | | | | | treatment |
| Example 3-2 | BPAF-PA | 31.8 | PMDA | 10.8 | TFMB | 30.9 | X-22-1660B-3 | 15.0 | Without |
| | | | | | | | | | treatment |
| Example 3-3 | BPAF-PA | 31.8 | PMDA | 10.8 | TFMB | 30.9 | X-22-1660B-3 | 15.0 | With |
| | | | | | | | | | treatment |
| Example 3-4 | BPAF-PA | 31.8 | PMDA | 10.8 | TFMB | 30.9 | X-22-1660B-3 | 15.0 | Without |
| | | | | | | | | | treatment |
| Example 3-5 | BPAF-PA | 32.1 | PMDA | 10.9 | TFMB | 30.6 | X-22-1660B-3 | 15.0 | Without |
| | | | | | | | | | treatment |

| | | | Weight- | | | | | |
|---|---|---|---|---|---|---|---|---|
| | | | average | Solid | Coating evaluation | | | |
| | Monomer | Synthesis | molecular | content | Slit nozzle | Coat gap | Edge | Slit coating |
| | drying | solvent | weight | (wt %) | evaluation | (um) | evaluation | coatability |
| Comparative | Without | NMP | 58,000 | 7 | Liquid | 167 | Liquid drip | Unacceptable |
| Example 3-1 | drying | | | | leakage | | | |
| Comparative | | NMP | 58,000 | 9 | Liquid | 136 | Liquid drip | |
| Example 3-2 | | | | | leakage | | | |
| Comparative | | NMP | 58,000 | 15 | Liquid | 98 | Liquid drip | |
| Example 3-3 | | | | | leakage | | | |
| Comparative | | NMP | 58,000 | 25 | Liquid | 50 | Liquid drip | |
| Example 3-4 | | | | | leakage | | | |
| Comparative | | NMP | 58,000 | 28 | No problem | 41 | No problem | |
| Example 3-5 | | | | | | | | |
| Example 3-1 | With | NMP | 71,000 | 25 | No problem | 50 | No problem | Acceptable |
| | drying | | | | | | | |
| Example 3-2 | With | NMP | 153,000 | 15 | No problem | 98 | No problem | Acceptable |
| Example 3-3 | drying | NMP | 149,000 | 15 | No problem | 98 | No problem | |
| Example 3-4 | | NMP/GBL | 153,000 | 15 | No problem | 110 | No problem | |
| | | (50/50) | | | | | | |
| Example 3-5 | With | NMP | 195,000 | 9 | No problem | 136 | No problem | Acceptable |
| | drying | | | | | | | |

TABLE 5

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Comparative | BPAF | 22.9 | PMDA | 10.9 | 4,4′-DAS | 24.2 | X-22-1660B-3 | 11.88 | Without |
| Example 4-1 | | | | | | | | | treatment |
| Comparative | BPAF | 22.9 | PMDA | 10.9 | 4,4′-DAS | 24.2 | X-22-1660B-3 | 11.88 | Without |
| Example 4-2 | | | | | | | | | treatment |
| Comparative | BPAF | 22.9 | PMDA | 10.9 | 4,4′-DAS | 24.2 | X-22-1660B-3 | 11.88 | Without |
| Example 4-3 | | | | | | | | | treatment |
| Comparative | BPAF | 22.9 | PMDA | 10.9 | 4,4′-DAS | 24.2 | X-22-1660B-3 | 11.88 | Without |
| Example 4-4 | | | | | | | | | treatment |
| Comparative | BPAF | 22.9 | PMDA | 10.9 | 4,4′-DAS | 24.2 | X-22-1660B-3 | 11.88 | Without |
| Example 4-5 | | | | | | | | | treatment |
| Example 4-1 | BPAF | 22.9 | PMDA | 10.9 | 4,4′-DAS | 23.9 | X-22-1660B-3 | 11.88 | Without |
| | | | | | | | | | treatment |
| Example 4-2 | BPAF | 22.7 | PMDA | 10.8 | 4,4′-DAS | 24.2 | X-22-1660B-3 | 11.88 | Without |
| | | | | | | | | | treatment |
| Example 4-3 | BPAF | 22.7 | PMDA | 10.8 | 3,3′-DAS | 24.2 | X-22-1660B-3 | 11.88 | Without |
| | | | | | | | | | treatment |
| Example 4-4 | BPAF | 22.7 | PMDA | 10.8 | 4,4′-DAS | 24.2 | X-22-1660B-3 | 11.88 | With |
| | | | | | | | | | treatment |
| Example 4-5 | BPAF | 22.7 | PMDA | 10.8 | 4,4′-DAS | 24.2 | X-22-1660B-3 | 11.88 | Without |
| | | | | | | | | | treatment |
| Example 4-6 | BPAF | 22.9 | PMDA | 10.9 | 4,4′-DAS | 23.9 | X-22-1660B-3 | 11.88 | Without |
| | | | | | | | | | treatment |
| | | | Weight- | | | | | | |

| | | Synthesis | average | Solid | Coating evaluation | | | |
|---|---|---|---|---|---|---|---|---|
| | Monomer | solvent | molecular | content | Slit nozzle | Coat gap | Edge | Slit coating |
| | drying | Type | weight | (wt %) | evaluation | (um) | evaluation | coatability |
| Comparative | Without | NMP | 57,000 | 7 | Liquid leakage | 167 | Liquid drip | Unacceptable |
| Example 4-1 | drying | | | | | | | |
| Comparative | | NMP | 57,000 | 9 | Liquid leakage | 136 | Liquid drip | |
| Example 4-2 | | | | | | | | |
| Comparative | | NMP | 57,000 | 15 | Liquid leakage | 98 | Liquid drip | |
| Example 4-3 | | | | | | | | |
| Comparative | | NMP | 57,000 | 25 | Liquid leakage | 50 | Liquid drip | |
| Example 4-4 | | | | | | | | |
| Comparative | | NMP | 57,000 | 28 | No problem | 41 | No problem | |
| Example 4-5 | | | | | | | | |
| Example 4-1 | With | NMP | 70,000 | 25 | No problem | 50 | No problem | Acceptable |
| | drying | | | | | | | |
| Example 4-2 | With | NMP | 149,000 | 15 | No problem | 98 | No problem | Acceptable |
| Example 4-3 | drying | NMP | 143,000 | 15 | No problem | 98 | No problem | |
| Example 4-4 | | NMP | 145,000 | 15 | No problem | 98 | No problem | |
| Example 4-5 | | NMP/GBL | 149,000 | 15 | No problem | 110 | No problem | |
| | | (50/50) | | | | | | |
| Example 4-6 | With | NMP | 193,000 | 9 | No problem | 136 | No problem | Acceptable |
| | drying | | | | | | | |

TABLE 6

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Comparative | BPAF | 22.9 | PMDA | 10.9 | FLDA | 33.8 | X-22-1660B-3 | 13.64 | Without |
| Example 5-1 | | | | | | | | | treatment |
| Comparative | BPAF | 22.9 | PMDA | 10.9 | FLDA | 33.8 | X-22-1660B-3 | 13.64 | Without |
| Example 5-2 | | | | | | | | | treatment |
| Comparative | BPAF | 22.9 | PMDA | 10.9 | FLDA | 33.8 | X-22-1660B-3 | 13.64 | Without |
| Example 5-3 | | | | | | | | | treatment |
| Comparative | BPAF | 22.9 | PMDA | 10.9 | FLDA | 33.8 | X-22-1660B-3 | 13.64 | Without |
| Example 5-4 | | | | | | | | | treatment |
| Comparative | BPAF | 22.9 | PMDA | 10.9 | FLDA | 33.8 | X-22-1660B-3 | 13.64 | Without |
| Example 5-5 | | | | | | | | | treatment |
| Example 5-1 | BPAF | 22.9 | PMDA | 10.9 | FLDA | 33.4 | X-22-1660B-3 | 13.64 | Without |
| | | | | | | | | | treatment |
| Example 5-2 | BPAF | 22.7 | PMDA | 10.8 | FLDA | 33.8 | X-22-1660B-3 | 13.64 | Without |
| | | | | | | | | | treatment |
| Example 5-3 | BPAF | 22.7 | PMDA | 10.8 | FLDA | 33.8 | X-22-1660B-3 | 13.64 | With |
| | | | | | | | | | treatment |
| Example 5-4 | BPAF | 22.7 | PMDA | 10.8 | FLDA | 33.8 | X-22-1660B-3 | 13.64 | Without |
| | | | | | | | | | treatment |
| Example 5-5 | BPAF | 22.9 | PMDA | 10.9 | FLDA | 33.4 | X-22-1660B-3 | 13.64 | Without |
| | | | | | | | | | treatment |
| | | | Weight- | | | | | | |

| | | | average | Solid | Coating evaluation | | | |
|---|---|---|---|---|---|---|---|---|
| | Monomer | Synthesis | molecular | content | Slit nozzle | Coat gap | Edge | Slit coating |
| | drying | solvent | weight | (wt %) | evaluation | (um) | evaluation | coatability |
| Comparative | Without | NMP | 56,000 | 7 | Liquid | 167 | Liquid drip | Unacceptable |
| Example 5-1 | drying | | | | leakage | | | |
| Comparative | | NMP | 56,000 | 9 | Liquid | 136 | Liquid drip | |
| Example 5-2 | | | | | leakage | | | |
| Comparative | | NMP | 56,000 | 15 | Liquid | 98 | Liquid drip | |
| Example 5-3 | | | | | leakage | | | |
| Comparative | | NMP | 56,000 | 25 | Liquid | 50 | Liquid drip | |
| Example 5-4 | | | | | leakage | | | |
| Comparative | | NMP | 56,000 | 28 | No problem | 41 | No problem | |
| Example 5-5 | | | | | | | | |
| Example 5-1 | With | NMP | 71,000 | 25 | No problem | 50 | No problem | Acceptable |
| | drying | | | | | | | |
| Example 5-2 | With | NMP | 153,000 | 15 | No problem | 98 | No problem | Acceptable |
| Example 5-3 | drying | NMP | 151,000 | 15 | No problem | 98 | No problem | |
| Example 5-4 | | NMP/GBL | 153,000 | 15 | No problem | 110 | No problem | |
| | | (50/50) | | | | | | |
| Example 5-5 | With | NMP | 194,000 | 9 | No problem | 136 | No problem | Acceptable |
| | drying | | | | | | | |

TABLE 7

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Comparative | BPAF | 22.9 | BPDA | 14.7 | CHDA | 11.2 | X-22-1660B-3 | 10.12 | Without |
| Example 6-1 | | | | | | | | | treatment |
| Comparative | BPAF | 22.9 | BPDA | 14.7 | CHDA | 11.2 | X-22-1660B-3 | 10.12 | Without |
| Example 6-2 | | | | | | | | | treatment |
| Comparative | BPAF | 22.9 | BPDA | 14.7 | CHDA | 11.2 | X-22-1660B-3 | 10.12 | Without |
| Example 6-3 | | | | | | | | | treatment |
| Comparative | BPAF | 22.9 | BPDA | 14.7 | CHDA | 11.2 | X-22-1660B-3 | 10.12 | Without |
| Example 6-4 | | | | | | | | | treatment |
| Comparative | BPAF | 22.9 | BPDA | 14.7 | CHDA | 11.2 | X-22-1660B-3 | 10.12 | Without |
| Example 6-5 | | | | | | | | | treatment |
| Example 6-1 | BPAF | 22.9 | BPDA | 14.7 | CHDA | 11.0 | X-22-1660B-3 | 10.12 | Without |
| | | | | | | | | | treatment |
| Example 6-2 | BPAF | 22.7 | BPDA | 14.6 | CHDA | 11.2 | X-22-1660B-3 | 10.12 | Without |
| | | | | | | | | | treatment |
| Example 6-3 | BPAF | 22.7 | BPDA | 14.6 | CHDA | 11.2 | X-22-1660B-3 | 10.12 | With |
| | | | | | | | | | treatment |
| Example 6-4 | BPAF | 22.7 | BPDA | 14.6 | CHDA | 11.2 | X-22-1660B-3 | 10.12 | Without |
| | | | | | | | | | treatment |
| Example 6-5 | BPAF | 22.9 | BPDA | 14.7 | CHDA | 11.0 | X-22-1660B-3 | 10.12 | Without |
| | | | | | | | | | treatment |
| | | | Weight- | | | | | | |

| | | | average | Solid | Coating evaluation | | | |
|---|---|---|---|---|---|---|---|---|
| | Monomer | Synthesis | molecular | content | Slit nozzle | Coat gap | Edge | Slit coating |
| | drying | solvent | weight | (wt %) | evaluation | (um) | evaluation | coatability |
| Comparative | Without | NMP | 53,000 | 7 | Liquid | 167 | Liquid drip | Unacceptable |
| Example 6-1 | drying | | | | leakage | | | |
| Comparative | | NMP | 53,000 | 9 | Liquid | 136 | Liquid drip | |
| Example 6-2 | | | | | leakage | | | |
| Comparative | | NMP | 53,000 | 15 | Liquid | 98 | Liquid drip | |
| Example 6-3 | | | | | leakage | | | |
| Comparative | | NMP | 53,000 | 25 | Liquid | 50 | Liquid drip | |
| Example 6-4 | | | | | leakage | | | |
| Comparative | | NMP | 53,000 | 28 | No problem | 41 | No problem | |
| Example 6-5 | | | | | | | | |
| Example 6-1 | With | NMP | 70,000 | 25 | No problem | 50 | No problem | Acceptable |
| | drying | | | | | | | |
| Example 6-2 | With | NMP | 142,000 | 15 | No problem | 98 | No problem | Acceptable |
| Example 6-3 | drying | NMP | 139,000 | 15 | No problem | 98 | No problem | |
| Example 6-4 | | NMP/GBL | 142,000 | 15 | No problem | 110 | No problem | |
| | | (50/50) | | | | | | |
| Example 6-5 | With | NMP | 193,000 | 9 | No problem | 136 | No problem | Acceptable |
| | drying | | | | | | | |

TABLE 8

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Comparative | BPAF | 22.9 | PMDA | 10.9 | TFMB | 31.1 | KF-8012 | 13.20 | Without |
| Example 7-1 | | | | | | | | | treatment |
| Comparative | BPAF | 22.9 | PMDA | 10.9 | TFMB | 31.1 | KF-8012 | 13.20 | Without |
| Example 7-2 | | | | | | | | | treatment |
| Comparative | BPAF | 22.9 | PMDA | 10.9 | TFMB | 31.1 | KF-8012 | 13.20 | Without |
| Example 7-3 | | | | | | | | | treatment |
| Comparative | BPAF | 22.9 | PMDA | 10.9 | TFMB | 31.1 | KF-8012 | 13.20 | Without |
| Example 7-4 | | | | | | | | | treatment |
| Comparative | BPAF | 22.9 | PMDA | 10.9 | TFMB | 31.1 | KF-8012 | 13.20 | Without |
| Example 7-5 | | | | | | | | | treatment |
| Example 7-1 | BPAF | 22.9 | PMDA | 10.9 | TFMB | 30.7 | KF-8012 | 13.20 | Without |
| | | | | | | | | | treatment |
| Example 7-2 | BPAF | 22.9 | PMDA | 10.9 | TFMB | 30.7 | KF-8012 | 13.20 | Without |
| | | | | | | | | | treatment |
| Example 7-3 | BPAF | 22.9 | PMDA | 10.9 | TFMB | 30.7 | KF-8012 | 13.20 | With |
| | | | | | | | | | treatment |
| Example 7-4 | BPAF | 22.9 | PMDA | 10.9 | TFMB | 30.7 | KF-8012 | 13.20 | Without |
| | | | | | | | | | treatment |
| Example 7-5 | BPAF | 22.7 | PMDA | 10.8 | TFMB | 31.1 | KF-8012 | 13.20 | Without |
| | | | | | | | | | treatment |
| Example 7-6 | BPAF | 22.9 | PMDA | 10.9 | TFMB | 30.7 | KF-8012 | 13.20 | Without |
| | | | | | | | | | treatment |
| | | | Weight- | Solid | | | | | |

| | | | average | content | Coating evaluation | | | |
|---|---|---|---|---|---|---|---|---|
| | Monomer | Synthesis | molecular | weight | Slit nozzle | Coat gap | Edge | Slit coating |
| | drying | solvent | weight | (wt %) | evaluation | (um) | Evaluation | coatability |
| Comparative | Without | NMP | 58,000 | 7 | Liquid | 167 | Liquid drip | Unacceptable |
| Example 7-1 | drying | | | | leakage | | | |
| Comparative | | NMP | 58,000 | 9 | Liquid | 136 | Liquid drip | |
| Example 7-2 | | | | | leakage | | | |
| Comparative | | NMP | 58,000 | 15 | Liquid | 98 | Liquid drip | |
| Example 7-3 | | | | | leakage | | | |
| Comparative | | NMP | 58,000 | 25 | Liquid | 50 | Liquid drip | |
| Example 7-4 | | | | | leakage | | | |
| Comparative | | NMP | 58,000 | 28 | No problem | 41 | No problem | |
| Example 7-5 | | | | | | | | |
| Example 7-1 | With | NMP | 73,000 | 25 | No problem | 50 | No problem | Acceptable |
| | drying | | | | | | | |
| Example 7-2 | With | NMP | 154,000 | 15 | No problem | 98 | No problem | Acceptable |
| Example 7-3 | drying | NMP | 148,000 | 15 | No problem | 98 | No problem | |
| Example 7-4 | | NMP/GBL | 154,000 | 15 | No problem | 110 | No problem | |
| | | (50/50) | | | | | | |
| Example 7-5 | With | NMP | 197,000 | 15 | No problem | 136 | No problem | Acceptable |
| | drying | | | | | | | |
| Example 7-6 | With | NMP | 248,000 | 9 | No problem | 136 | No problem | Acceptable |
| | drying | | | | | | | |

TABLE 9

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Comparative | BPAF | 22.2 | PMDA | 10.6 | TFMB | 32.0 | X-22-168-P5-B | 13.44 | Without |
| Example 8-1 | | | | | | | | | treatment |
| Comparative | BPAF | 22.2 | PMDA | 10.6 | TFMB | 32.0 | X-22-168-P5-B | 13.44 | Without |
| Example 8-2 | | | | | | | | | treatment |
| Comparative | BPAF | 22.2 | PMDA | 10.6 | TFMB | 32.0 | X-22-168-P5-B | 13.44 | Without |
| Example 8-3 | | | | | | | | | treatment |
| Comparative | BPAF | 22.2 | PMDA | 10.6 | TFMB | 32.0 | X-22-168-P5-B | 13.44 | Without |
| Example 8-4 | | | | | | | | | treatment |
| Comparative | BPAF | 22.2 | PMDA | 10.6 | TFMB | 32.0 | X-22-168-P5-B | 13.44 | Without |
| Example 8-5 | | | | | | | | | treatment |
| Example 8-1 | BPAF | 22.2 | PMDA | 10.6 | TFMB | 31.7 | X-22-168-P5-B | 13.44 | Without |
| | | | | | | | | | treatment |
| Example 8-2 | BPAF | 22.0 | PMDA | 10.4 | TFMB | 32.0 | X-22-168-P5-B | 13.44 | Without |
| | | | | | | | | | treatment |
| Example 8-3 | BPAF | 22.0 | PMDA | 10.4 | TFMB | 32.3 | X-22-168-P5-B | 13.44 | With |
| | | | | | | | | | treatment |
| Example 8-4 | BPAF | 22.0 | PMDA | 10.4 | TFMB | 32.7 | X-22-168-P5-B | 13.44 | Without |
| | | | | | | | | | treatment |
| Example 8-5 | BPAF | 22.2 | PMDA | 10.6 | TFMB | 31.7 | X-22-168-P5-B | 13.44 | Without |
| | | | | | | | | | treatment |
| | | | Weight- | | | | | | |

| | | | average | Solid | Coating evaluation | | | |
|---|---|---|---|---|---|---|---|---|
| | Monomer | Synthesis | molecular | content | Slit nozzle | Coat gap | Edge | Slit coating |
| | drying | solvent | weight | (wt %) | evaluation | (um) | evaluation | coatability |
| Comparative | Without | NMP | 52,000 | 7 | Liquid | 167 | Liquid drip | Unacceptable |
| Example 8-1 | drying | | | | leakage | | | |
| Comparative | | NMP | 52,000 | 9 | Liquid | 136 | Liquid drip | |
| Example 8-2 | | | | | leakage | | | |
| Comparative | | NMP | 52,000 | 15 | Liquid | 98 | Liquid drip | |
| Example 8-3 | | | | | leakage | | | |
| Comparative | | NMP | 52,000 | 25 | Liquid | 50 | Liquid drip | |
| Example 8-4 | | | | | leakage | | | |
| Comparative | | NMP | 52,000 | 28 | No problem | 41 | No problem | |
| Example 8-5 | | | | | | | | |
| Example 8-1 | With | NMP | 70,000 | 25 | No problem | 50 | No problem | Acceptable |
| | drying | | | | | | | |
| Example 8-2 | With | NMP | 146,000 | 15 | No problem | 98 | No problem | Acceptable |
| Example 8-3 | drying | NMP | 141,000 | 15 | No problem | 98 | No problem | |
| Example 8-4 | | NMP/GBL | 146,000 | 15 | No problem | 110 | No problem | |
| | | (50/50) | | | | | | |
| Example 8-5 | With | NMP | 194,000 | 9 | No problem | 136 | No problem | Acceptable |
| | drying | | | | | | | |

TABLE 10

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Comparative | BPAF | 22.0 | PMDA | 10.5 | TFMB | 32.0 | X-22-168B | 13.12 | Without |
| Example 9-1 | | | | | | | | | treatment |
| Comparative | BPAF | 22.0 | PMDA | 10.5 | TFMB | 32.0 | X-22-168B | 13.12 | Without |
| Example 9-2 | | | | | | | | | treatment |
| Comparative | BPAF | 22.0 | PMDA | 10.5 | TFMB | 32.0 | X-22-168B | 13.12 | Without |
| Example 9-3 | | | | | | | | | treatment |
| Comparative | BPAF | 22.0 | PMDA | 10.5 | TFMB | 32.0 | X-22-168B | 13.12 | Without |
| Example 9-4 | | | | | | | | | treatment |
| Comparative | BPAF | 22.0 | PMDA | 10.5 | TFMB | 32.0 | X-22-168B | 13.12 | Without |
| Example 9-5 | | | | | | | | | treatment |
| Example 9-1 | BPAF | 22.0 | PMDA | 10.5 | TFMB | 31.7 | X-22-168B | 13.12 | Without |
| | | | | | | | | | treatment |
| Example 9-2 | BPAF | 21.8 | PMDA | 10.3 | TFMB | 32.0 | X-22-168B | 13.12 | Without |
| | | | | | | | | | treatment |
| Example 9-3 | BPAF | 21.8 | PMDA | 10.3 | TFMB | 32.3 | X-22-168B | 13.12 | With |
| | | | | | | | | | treatment |
| Example 9-4 | BPAF | 21.8 | PMDA | 10.3 | TFMB | 32.7 | X-22-168B | 13.12 | Without |
| | | | | | | | | | treatment |
| Example 9-5 | BPAF | 22.0 | PMDA | 10.5 | TFMB | 31.7 | X-22-168B | 13.12 | Without |
| | | | | | | | | | treatment |
| | | | Weight- | | | | | | |

| | | | average | Solid | Coating evaluation | | | |
|---|---|---|---|---|---|---|---|---|
| | Monomer | Synthesis | molecular | content | Slit nozzle | Coat gap | Edge | Slit coating |
| | drying | solvent | weight | (wt %) | evaluation | (um) | evaluation | coatability |
| Comparative | Without | NMP | 52,000 | 7 | Liquid | 167 | Liquid drip | Unacceptable |
| Example 9-1 | drying | | | | leakage | | | |
| Comparative | | NMP | 52,000 | 9 | Liquid | 136 | Liquid drip | |
| Example 9-2 | | | | | leakage | | | |
| Comparative | | NMP | 52,000 | 15 | Liquid | 98 | Liquid drip | |
| Example 9-3 | | | | | leakage | | | |
| Comparative | | NMP | 52,000 | 25 | Liquid | 50 | Liquid drip | |
| Example 9-4 | | | | | leakage | | | |
| Comparative | | NMP | 52,000 | 28 | No problem | 41 | No problem | |
| Example 9-5 | | | | | | | | |
| Example 9-1 | With | NMP | 70,000 | 25 | No problem | 50 | No problem | Acceptable |
| | drying | | | | | | | |
| Example 9-2 | With | NMP | 151,000 | 15 | No problem | 98 | No problem | Acceptable |
| Example 9-3 | drying | NMP | 148,000 | 15 | No problem | 98 | No problem | |
| Example 9-4 | | NMP/GBL | 151,000 | 15 | No problem | 110 | No problem | |
| | | (50/50) | | | | | | |
| Example 9-5 | With | NMP | 191,000 | 9 | No problem | 136 | No problem | Acceptable |
| | drying | | | | | | | |

TABLE 11

| | Acid | | Acid | | | | | | |
|---|---|---|---|---|---|---|---|---|---|
| | dianhydride 1 | | dianhydride 2 | | Diamine 1 | | Silicon-containing compound | | |
| | | Amount | | Amount | | Amount | | Amount | Purification |
| | Type | (g) | Type | (g) | Type | (g) | Type | (g) | treatment |
| Example 1-2 | BPAF | 22.9 | PMDA | 10.9 | TFMB | 30.7 | X-22-1660B-3 | 13.20 | Without |
| | | | | | | | | | treatment |
| Example 1-3 | BPAF | 22.9 | PMDA | 10.9 | TFMB | 30.7 | X-22-1660B-3 | 13.20 | With |
| | | | | | | | | | treatment |
| Example 3-2 | BPAF-PA | 31.8 | PMDA | 10.8 | TFMB | 30.9 | X-22-1660B-3 | 15.0 | Without |
| | | | | | | | | | treatment |
| Example 3-3 | BPAF-PA | 31.8 | PMDA | 10.8 | TFMB | 30.9 | X-22-1660B-3 | 15.0 | With |
| | | | | | | | | | treatment |
| Example 7-2 | BPAF | 22.9 | PMDA | 10.9 | TFMB | 30.7 | KF-8012 | 13.20 | Without |
| | | | | | | | | | treatment |
| Example 7-3 | BPAF | 22.9 | PMDA | 10.9 | TFMB | 30.7 | KF-8012 | 13.20 | With |
| | | | | | | | | | treatment |
| Example 8-2 | BPAF | 22.0 | PMDA | 10.4 | TFMB | 32.0 | X-22-168-P5-B | 13.44 | Without |
| | | | | | | | | | treatment |
| Example 8-3 | BPAF | 22.0 | PMDA | 10.4 | TFMB | 32.3 | X-22-168-P5-B | 13.44 | With |
| | | | | | | | | | treatment |
| Example 9-2 | BPAF | 21.8 | PMDA | 10.3 | TFMB | 32.0 | X-22-168B | 13.12 | Without |
| | | | | | | | | | treatment |
| Example 9-3 | BPAF | 21.8 | PMDA | 10.3 | TFMB | 32.3 | X-22-168B | 13.12 | With |
| | | | | | | | | | treatment |

Amount of cyclic siloxane
[ppm]

| | | | | | |
|---|---|---|---|---|---|
| | Weight- | | | Silicon | Film |
| Polymerization | average | Solid | Solid | containing- | evaluation |

| | solvent | molecular | content | Composition | content | compound | Difference |
|---|---|---|---|---|---|---|---|
| | Type | weight | (wt %) | basis | basis | basis | in YI value |
| Example 1-2 | NMP | 156,000 | 15 | 521 | 3256 | 1753 | — |
| Example 1-3 | NMP | 151,000 | 15 | 124 | 621 | 298 | 1.8 |
| Example 3-2 | NMP | 153,000 | 15 | 521 | 3256 | 1753 | — |
| Example 3-3 | NMP | 149,000 | 15 | 124 | 621 | 298 | 1.6 |
| Example 7-2 | NMP | 154,000 | 15 | 1216 | 8518 | 1932 | — |
| Example 7-3 | NMP | 148,000 | 15 | 283 | 1253 | 426 | 1.5 |
| Example 8-2 | NMP | 146,000 | 15 | 453 | 2431 | 1321 | — |
| Example 8-3 | NMP | 141,000 | 15 | 102 | 323 | 243 | 1.8 |
| Example 9-2 | NMP | 151,000 | 15 | 920 | 6723 | 1189 | — |
| Example 9-3 | NMP | 148,000 | 15 | 214 | 723 | 376 | 1.5 |

TABLE 12

| | Acid dianhydride 1 | | | Acid dianhydride 2 | | | Diamine 1 | | |
|---|---|---|---|---|---|---|---|---|---|
| | | Amount | Amount | | Amount | Amount | | Amount | |
| | Type | (mmol) | (g) | Type | (mmol) | (g) | Type | (mmol) | (g) |
| Example 1-1 | BPAF | 50 | 22.9 | PMDA | 50 | 10.9 | TFMB | 96.0 | 30.7 |
| Comparative | | | 0.0 | PMDA | 100 | 21.8 | TFMB | 96.0 | 30.7 |
| Example 12-1 | | | | | | | | | |
| Example 1-7 | BPAF | 50 | 22.9 | PMDA | 50 | 10.9 | TFMB | 96.0 | 30.7 |
| Comparative | | | 0.0 | PMDA | 100 | 21.8 | TFMB | 96.0 | 30.7 |
| Example 12-2 | | | | | | | | | |

Silicon-containing compound

| | | Amount | Amount | Si | Purification | Monomer |
|---|---|---|---|---|---|---|
| | Type | (mmol) | (g) | amount | treatment | drying |
| Example 1-1 | X-22-1660B-3 | 3.000 | 13.20 | 16.97 | Without | With |
| | | | | | treatment | drying |
| Comparative | X-22-1660B-3 | 3.000 | 13.20 | 20.08 | Without | With |
| Example 12-1 | | | | | treatment | drying |
| Example 1-7 | X-22-1660B-3 | 3.000 | 13.20 | 16.97 | Without | With |
| | | | | | treatment | drying |
| Comparative | X-22-1660B-3 | 3.000 | 13.20 | 20.08 | Without | With |
| Example 12-2 | | | | | treatment | drying |
| | Molar ratio of | | Synthesis | | Weight- | |
| | diamine/acid | | solvent | | average | Solid |
| | dianhydride | Reaction | | Weight | molecular | content |
| | A:B ratio (B/A) | condition | Type | (g) | weight | (wt %) |
| Example 1-1 | 0.99 | 80° C.*3 h | NMP | 233 | 71,000 | 25 |
| Comparative | 0.99 | 80° C.*3 h | NMP | 197 | 78,000 | 25 |
| Example 12-1 | | | | | | |
| Example 1-7 | 0.99 | 80° C.*3 h | NMP | 786 | 248,000 | 9 |
| Comparative | 0.99 | 80° C.*3 h | NMP | 665 | 253,000 | 9 |
| Example 12-2 | | | | | | |
| | Coating evaluation | | | | | |
| | | Coat | | | | Film |
| | Slit nozzle | gap | Edge | | Slit coating | evaluation |
| | evaluation | (um) | evaluation | | coatability | Rth |
| Example 1-1 | No problem | 50 | No problem | | Acceptable | 43 |
| Comparative | No problem | 50 | No problem | | Acceptable | 174 |
| Example 12-1 | | | | | | |
| Example 1-7 | No problem | 136 | No problem | | Acceptable | 58 |
| Comparative | No problem | 136 | No problem | | Acceptable | 188 |
| Example 12-2 | | | | | | |

### EXPLANATION OF ABBREVIATIONS IN TABLES

<Acid Dianhydride>
BPAF: 9,9-bis(3,4-dicarboxyphenyl)fluorene dianhydride
BPAF-PA: 9,9-bis[4-(3,4-dicarboxyphenoxy)phenyl]fluorene dianhydride
PMDA: pyromellitic dianhydride

<Diamine>
TFMB: 2,2′-diaminobis(trifluoromethyl)biphenyl
4,4′DAS: 4,4′-diaminodiphenyl sulfone,
3,3′DAS: 3,3′-diaminodiphenyl sulfone
FLDA: 9,9-bis(4-aminophenyl)fluorene
CHDA: 1,4-diaminocyclohexane

<Silicon-Containing Compound>
X-22-1660 B-3: Both amino end-modified methyl phenyl silicone oil, functional group equivalent 2200, manufactured by Shin-Etsu Chemical Co., Ltd.
KF-8012: Both amino end-modified methyl silicone oil, functional group equivalent 2200, manufactured by Shin-Etsu Chemical Co., Ltd.
X-22-168-P5-B: Both carboxylic acid anhydride end-modified methyl phenyl silicone oil, functional group equivalent 2100, manufactured by Shin-Etsu Chemical Co., Ltd.
X-22-168B: Both carboxylic acid anhydride end-modified methyl phenyl silicone oil, functional group equivalent 1600, manufactured by Shin-Etsu Chemical Co., Ltd.

<Solvent>
NMP: N-methyl-2-pyrrolidone
GBL: γ-butyrolactone

### EXPLANATION OF SYMBOLS

2a Lower substrate
2b Sealing substrate
25 Portion of organic EL structure
250a Organic EL element emitting red light
250b Organic EL element emitting green light
250c Organic EL element emitting blue light
251 Partition wall (bank)
252 Lower electrode (anode)
253 Hole transport layer
254 Light emitting layer
255 Upper electrode (cathode)
256 TFT
257 Contact hole
258 Interlayer dielectric film
259 Lower electrode
261 Hallow portion

What is claimed is:

1. A resin composition comprising a polyimide precursor and a solvent, wherein the polyimide precursor is represented by formula (1): 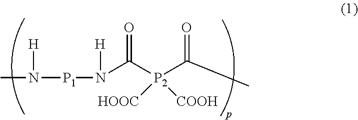
wherein P₁ represents a divalent organic group, if P₁ is plural, P₁ each may be the same or different, P₂ represents a tetravalent group represented by formula (2): 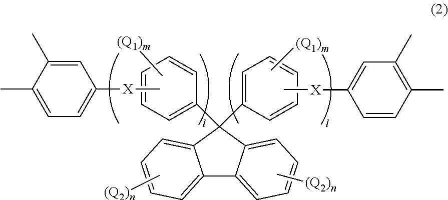
wherein Q₁ and Q₂ are each independently at least one selected from the group consisting of an alkyl group, an aryl group, an arylalkyl group and a halogenated alkyl group, X is each independently at least one selected from the group consisting of —O—, —C(═O)—, —C(═O)O— and —C(═O)NH—, m and n are each independently an integer of 0 to 2, and 1 is an integer of 0 or 1,
if P₂ is plural, P₂ each may be the same or different and p is a positive integer, and has a structure unit represented by formula (3): 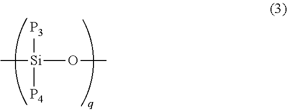
wherein P₃ and P₄ are each independently a monovalent aliphatic hydrocarbon group of 1 to 5 carbon atoms or a monovalent aromatic group of 6 to 10 carbon atoms, if P₃ is plural, P₃ each may be the same or different, if P₄ is plural, P₄ each may be the same or different and q is a positive integer, and
the resin composition comprises a compound represented by formula (4): 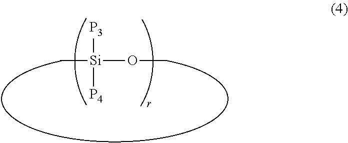
wherein P₅ and P₆ are each independently a monovalent aliphatic hydrocarbon of 1 to 5 carbon atoms or an aromatic group of 6 to 10 carbon atoms and r is an integer of 3 or more, in an amount of greater than 0 ppm and 300 ppm or less based on a weight of the resin composition, and/or in an amount of greater than 0 ppm and 1500 ppm or less based on a solid content weight in the resin composition.

2. A resin composition comprising a polyimide precursor and a solvent, wherein the polyimide precursor is represented by formula (1): 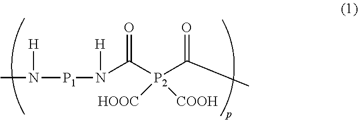
wherein P₁ represents a divalent organic group, if P₁ is plural, P₁ each may be the same or different, P₂ represents a tetravalent group represented by formula (2): 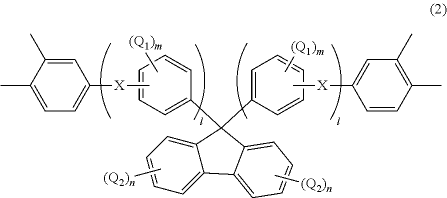
wherein Q₁ and Q₂ are each independently at least one selected from the group consisting of an alkyl group, an aryl group, an arylalkyl group and a halogenated alkyl group, X is each independently at least one selected from the group consisting of —O—, —C(═O)—, —C(═O)O— and —C(═O)NH—, m and n are each independently an integer of 0 to 2, and 1 is an integer of 0 or 1;
if P₂ is plural, P₂ each may be the same or different, and p is a positive integer, and has a structure unit represented by formula (3): 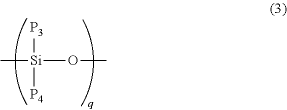
wherein P₃ and P₄ are each independently a monovalent aliphatic hydrocarbon group of 1 to 5 carbon atoms or a monovalent aromatic group of 6 to 10 carbon atoms, if P₃ is plural, P₃ each may be the same or different, if P₄ is plural, P₄ each may be the same or different, and q is a positive integer,
the resin composition comprises a compound represented by formula (4): 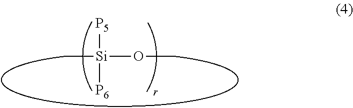
wherein P₅ and P₆ are each independently a monovalent aliphatic hydrocarbon of 1 to 5 carbon atoms or an aromatic group of 6 to 10 carbon atoms and r is an integer of 3 or more,
the polyimide precursor is a copolymer containing as monomer units:
a silicon-containing compound represented by formula (5): 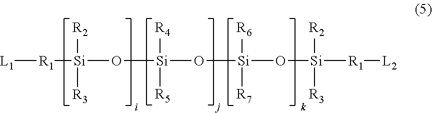
wherein R₁ is each independently, single bond or a divalent organic group of 1 to 10 carbon atoms, R₂ and R₃ are each independently a monovalent aliphatic hydrocarbon group of 1 to 5 carbon atoms, R₄ and R₅ are each independently a monovalent aromatic group of 6 to 10 carbon atoms, R₆ and R₇ are each independently a monovalent organic group of 1 to 10 carbon atoms, at least one of R₆ and R is an organic group having an unsaturated aliphatic hydrocarbon group, L₁ and L₂ are each independently an amino group, an acid anhydride group, an isocyanate group, a carboxy group, an acid ester group, an acid halide group, a hydroxy group, an epoxy group or a mercapto group, i is an integer of 1 to 200, and j and k are each independently an integer of 0 to 200,
tetracarboxylic dianhydride, and
diamine; and
a content of the compound represented by formula (4) in the resin composition is greater than 0 ppm and 450 ppm or less based on 100 parts by weight of a total weight of the silicon-containing compounds represented by formulas (4) and (5).

3. The resin composition according to claim 1 wherein a weight-average molecular weight of the polyimide precursor is 90,000 to 250,000.

4. The resin composition according to claim 1, wherein a weight-average molecular weight of the polyimide precursor is more than 96,000.

5. The resin composition according to claim 1, wherein a weight-average molecular weight of the polyimide precursor is 139,000 or more and/or 180,000 or less.

6. The resin composition according to claim 1, wherein P₅ and P₆ are each independently a monovalent aliphatic hydrocarbon of 1 to 5 carbon atoms, and r is 3 to 8, in formula (4).

7. The resin composition according to claim 1, wherein P₅ and P₆ are each independently an aromatic group of 6 to 10 carbon atoms, and r is 3 to 8, in formula (4).

8. The resin composition according to claim 1, wherein a solid content of the resin composition is 9 to 25% by weight, 9 to 20% by weight, 9 to 15% by weight, or 9 to 13% by weight.

9. The resin composition according to claim 1, wherein a polyimide resin film which is a cured product of the polyimide precursor is used for a flexible substrate.

10. The resin composition according to claim 1, wherein a polyimide resin film which is a cured product of the polyimide precursor is used for a flexible display.

11. A method of preparing a polyimide film, comprising:
coating a surface of a support with the resin composition according to claim 1;
forming a polyimide resin film by heating the resin composition; and
stripping the polyimide resin film from the support.

12. The method according to claim 11, which comprises irradiating a laser to the resin composition from the support side prior to the stripping.

13. A method of preparing a display, comprising:
coating a surface of a support with the resin composition according to claim 1;
forming a polyimide resin film by heating the resin composition;
forming an element on the polyimide resin film; and
stripping the polyimide resin film on which the element is formed from the support.

14. A method of preparing a laminate, comprising:
coating a surface of a support with the resin composition according to claim 1;
forming a polyimide resin film by heating the resin composition; and
forming an element on the polyimide resin film.

15. The method according to claim 14, which further comprises stripping the polyimide resin film on which the element is formed from the support.

16. A method of preparing a flexible device, comprising preparing the laminate according to the method of claim 14.

17. A polyimide film, which is a cured product of the resin composition according to claim 1.
